(19) United States
(12) Patent Application Publication
(10) Pub. No.: US 2026/0111180 A1
(43) Pub. Date: Apr. 23, 2026

(54) INTEGRATED DEVELOPMENT ENVIRONMENT (IDE) EXTENSION FOR HOLISTIC SOFTWARE DEVELOPMENT LIFECYCLE (SDLC) MANAGEMENT

(71) Applicant: JPMorgan Chase Bank, N.A., New York, NY (US)

(72) Inventors: Markandey Pathak, Glasgow (GB); Georgia Constantinou, Bathgate (GB); Jack D. Erskine, Glasgow (GB); Prarubdha Janwe, Glasgow (GB); Ashly Kurian, Glasgow (GB)

(73) Assignee: JPMorgan Chase Bank, N.A., New York, NY (US)

(21) Appl. No.: 19/365,689

(22) Filed: Oct. 22, 2025

Related U.S. Application Data
(60) Provisional application No. 63/710,740, filed on Oct. 23, 2024.

(51) Int. Cl. G06F 8/33; G06F 8/35; G06F 8/36

(52) U.S. Cl. CPC G06F 8/33; G06F 8/35; G06F 8/36

(57) ABSTRACT

Aspects of the subject disclosure may include, for example, receiving information relating to a user input from an IDE, deriving a first instruction based on the information for directing a first external tool to perform action(s), wherein the first external tool provides functionality for managing one stage of an SDLC, sending the first instruction to the first external tool to perform the action(s), obtaining, from the first external tool, data relating to performing of the action(s), deriving a second instruction based on the data for directing a second external tool to perform other action(s), wherein the second external tool provides functionality for managing another stage of the SDLC, and sending the second instruction to the second external tool to perform the other action(s), thereby facilitating centralized access to and control of operations of different external tools associated with different stages of the SDLC. Other embodiments are disclosed.

### CROSS-REFERENCE TO RELATED APPLICATION

The present application claims the benefit of priority to U.S. Provisional Application No. 63/710,740 filed on Oct. 23, 2024, which is hereby incorporated herein by reference in its entirety.

### FIELD OF THE DISCLOSURE

The subject disclosure relates to integration of an integrated development environment (IDE) with tools/systems that are used across different stages of a Software Development Lifecycle (SDLC).

### BACKGROUND

Software development is a highly engineer-centric process, involving multiple stages that collectively form the SDLC. This lifecycle typically includes five main stages: plan, design, build, deploy, and monitor. The planning stage involves defining the project scope, requirements, objectives, etc. This is followed by the design stage, where the architecture and any user interface (UI) of the software are conceptualized. The build stage is where the actual coding and development of the software take place. Once the software is built, it moves to the deployment stage, where it is eventually released to the production environment. Finally, the monitoring stage involves tracking the software's performance, user interactions, and any issues that arise, which can be fed back into the planning stage for continuous improvement. Each stage of the SDLC is typically managed through one or more specialized tools. For example, the planning stage is typically handled using planning tools (e.g., project management tools), the design stage is typically managed using documentation tools, the build stage is typically conducted within IDEs where source code for builds is typically managed through source code management (SCM) and continuous integration (CI) tools, and deployments and monitoring are typically done using continuous deployment (CD) tools that deploy the software into one or more environments and obtain performance data from the environment(s).

During the entire SDLC, engineers are involved in each of its stages and thus often need to switch between different tools that are specifically designed for the individual stages. For instance, during the build stage, engineers often need to access project management tools, documentation and design tools, as well as IDEs, SCMs, and CI tools. While this hopping between tools helps engineers maintain awareness of their tasks, understand how they should proceed, and evaluate the performance of their work, the frequent switching between these tools can be exhausting, can disrupt the engineers'workflow, and can increase the likelihood of errors and miscommunication. Although the IDE is the primary tool that engineers use to build software, the scattered nature of tasks across multiple systems also means that engineers spend minimal time in the IDE and more time managing other tools. This results in significant overhead, lost time, and inefficient SDLC management. Additionally, this fragmented approach also requires the use of different methods for accessing the heterogeneous tools, including the use of different data transmission protocols for sending/receiving data from these tools, which poses security vulnerabilities as engineers individually access the tools. Such access is also prone to redundant or inefficient data requests, which can result in inefficient computer resource usage and thus increased computational overhead.

### SUMMARY OF THE DISCLOSURE

One or more aspects of the subject disclosure may include a method. The method may include receiving, by a processing system including a processor, information relating to a user input from an integrated development environment (IDE). Further, the method may include deriving, by the processing system, a first instruction based on the information for directing a first external tool to perform one or more actions, wherein the first external tool provides functionality for managing one stage of a software development lifecycle (SDLC). Further, the method may include sending, by the processing system, the first instruction to the first external tool to trigger the first external tool to perform the one or more actions. Further, the method may include responsive to the sending, obtaining, by the processing system and from the first external tool, data relating to performing of the one or more actions. Further, the method may include deriving, by the processing system, a second instruction based on the data for directing a second external tool to perform one or more other actions, wherein the second external tool provides functionality for managing another stage of the SDLC. Further, the method may include sending, by the processing system, the second instruction to the second external tool to trigger the second external tool to perform the one or more other actions, thereby facilitating centralized access to and control of operations of different external tools associated with different stages of the SDLC.

One or more aspects of the subject disclosure may include a device, comprising a processing system including a processor, and a memory that stores executable instructions that, when executed by the processing system, facilitate performance of operations. The operations may include detecting a user command from an integrated development environment (IDE). Further, the operations may include causing a first external tool to perform one or more actions based on the user command, wherein the first external tool provides functionality for managing one stage of a software development lifecycle (SDLC). Further, the operations may include receiving data from the first external tool relating to performing of the one or more actions. Further, the operations may include based on the data, causing a second external tool to perform one or more other actions, wherein the second external tool provides functionality for managing another stage of the SDLC. Further, the operations may include obtaining information from the second external tool relating to performing of the one or more other actions. Further, the operations may include causing the IDE to present one or more of the data or the information on a user interface (UI) of the IDE, thereby facilitating centralized access to and control of operations of different external tools associated with different stages of the SDLC.

One or more aspects of the subject disclosure may include a non-transitory machine-readable medium, comprising executable instructions that, when executed by a processing system including a processor, facilitate performance of operations. The operations may include receiving information relating to a user input from an integrated development environment (IDE). Further, the operations may include deriving a first instruction based on the information for causing a first external tool to perform one or more actions, wherein the first external tool is associated with management of one or more stages of a software development lifecycle (SDLC). Further, the operations may include sending the first instruction to the first external tool to trigger the first external tool to perform the one or more actions. Further, the operations may include responsive to the sending, obtaining, from the first external tool, data relating to performing of the one or more actions. Further, the operations may include deriving a second instruction based on the data for causing a second external tool to perform one or more other actions, wherein the second external tool is associated with management of one or more other stages of the SDLC. Further, the operations may include providing the second instruction to the second external tool to trigger the second external tool to perform the one or more other actions, thereby facilitating centralized access to and control of operations of different external tools associated with different stages of the SDLC.

### BRIEF DESCRIPTION OF THE DRAWINGS

Reference will now be made to the accompanying drawings, which are not necessarily drawn to scale, and wherein:

FIG. 1 illustrates an example environment in which an extension system facilitates integration between an IDE and various tools/systems that are used across different stages of an SDLC.

FIG. 2 illustrates a detailed view of the example environment, showing the specific tools/systems and corresponding plugins that facilitate integration of these tools/systems with the IDE.

FIG. 2A illustrates an example UI of the IDE.

FIG. 2B illustrates an example call flow for updating task status in a planning tool/system.

FIG. 2C illustrates an example call flow for associating code with a ticket in a planning tool/system.

FIG. 2D illustrates an example call flow for managing project documentation.

FIG. 2E illustrates an example call flow for committing code to an SCM tool/system and updating a planning tool/system.

FIG. 2F illustrates an example call flow for triggering a build and handling a pull request.

FIG. 2G illustrates an example call flow for deploying a build to a particular environment.

FIG. 2H illustrates an example call flow for obtaining and displaying a deployment log.

FIG. 2I illustrates an example call flow for monitoring a deployed application.

FIG. 2J illustrates an example call flow for facilitating identification of project management information based on a user selection of particular source code.

FIG. 2K illustrates an example call flow for displaying documentation for a selected application feature.

FIG. 2L illustrates an example call flow for creating a branch for a selected application feature.

FIG. 2M illustrates an example call flow for checking if there is a pull request for a selected branch.

FIG. 2N illustrates an example process implemented by an artificial intelligence (AI) system.

FIG. 2O illustrates a detailed view of another example environment, showing the specific tools/systems and corresponding AI agents that facilitate integration of these tools/systems with the IDE.

FIG. 2P depicts an illustrative embodiment of a method in accordance with various aspects described herein.

FIG. 3A is a diagram of an example AI architecture, which may be used to facilitate training or pre-training of one or more large language models (LLMs), in accordance with various aspects described herein.

FIG. 3B is a diagram of an example transformer model, a portion or an entirety of which may serve as a functional building block of one or more LLMs, in accordance with various aspects described herein.

FIG. 4 is a block diagram of an example, non-limiting embodiment of a computing environment in accordance with various aspects described herein.

### DETAILED DESCRIPTION

The subject disclosure generally relates to an extension system for an IDE that facilitates integration of the IDE with various tools/systems that are used across different stages of an SDLC. In exemplary embodiments, the extension system may be implemented in a set of plugins that respectively interface with corresponding tools/systems, such as planning tool(s)/system(s), documentation tool(s)/system(s), SCM and/or CI tool(s)/system(s), CD tool(s)/system(s), and/or environment(s). In one or more embodiments, the plugins may facilitate data exchange and command execution between the IDE and the various tools/systems via application programming interfaces (APIs) and/or command line interfaces (CLIs) associated with those tools/systems. In certain alternate embodiments, the extension system may be implemented in a set of AI agents as part of an agentic AI framework, which functions as a centralized orchestrator between the IDE and the various tools/systems.

As described in more detail below, the extension system may be capable of preparing a view within the IDE that provides a snapshot of relevant information from the various tools/systems, which allows a user (e.g., an engineer or developer) to access such information within the IDE without needing to switch between the different tools/systems. The view may, for instance, include a summary of the user's tasks (e.g., pull requests), comments received from peers, the status of deployed resources, issues or log analysis (e.g., relating to particular lines of code, API requests, etc.), and/or the like.

It is believed that there is presently no single platform where engineers can manage the entire SDLC. The current fragmented approach to SDLC forces engineers to switch between the use of multiple tools for the various stages, which leads to inefficiencies and increased overhead. Exemplary embodiments of the extension system advantageously address these issues by providing a unified platform that integrates all stages of the SDLC within a single environment. By providing one-stop SDLC management, engineers can handle (e.g., all) aspects of the development lifecycle from a single interface. This reduces or eliminates the need for the engineer to switch between different tools, thereby reducing or eliminating context switches and disruptions to workflow. Additionally, the extension system may provide proactive notifications that help reduce the time and effort that engineers spend throughout various SDLC stages, e.g., to monitor user-story changes, design changes, pull-requests, and deployments. In this way, engineers can receive (e.g., real-time) updates and alerts within the IDE itself, which enables them to respond promptly to issues and changes without having to manually check external systems. Furthermore, the extension system saves time and effort in building and configuring deployment pipelines by offering visual configuration elements. This user-friendly approach simplifies the setup and management of deployment processes, which makes it easier for engineers to deploy applications efficiently and accurately. Exemplary embodiments of the extension system provide for coordination of operations involving the various tools/systems, including the use of consistent (e.g., API-based) system access and data transmission protocols across the tools, which advantageously mitigates vulnerabilities associated with data breaches or the like that would otherwise be prevalent if engineers were to separately access the individual tools using different access methods. Exemplary embodiments of the extension system also improve computer functionality by streamlining data access and reducing the computational overhead that might otherwise result from engineers running applications to open or access the different interfaces of the external tools. By centralizing data exchanges with/between the tools, therefore, the extension system efficiently controls interactions with/between various tools, which reduces the possibility of redundant data requests and processing, thereby providing for more efficient memory and processing power usage.

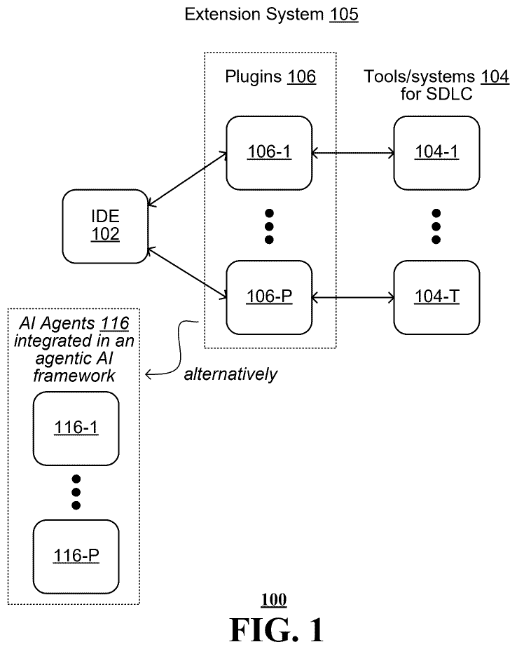

Referring to FIG. 1, an environment 100 may include an IDE 102 and one or more tools/systems 104-1 through 104-T (T≥1) (hereinafter referred to collectively as “tools/systems 104,” and individually as “tool/system 104” or by specific designation [e.g., tool/system 104-1, 104-2, 104-3, etc.]).

The IDE 102 may be a software platform that provides a comprehensive suite of tools for software development. The IDE 102 may provide a unified interface for developers to write, test, and/or debug code in one or more programming languages. The IDE 102 may offer features such as syntax highlighting, code completion, version control integration, etc. The IDE 102 may run or be executed on one or more computing devices. The IDE 102 may be deployed locally on individual machines or served from device(s) in a cloud environment.

The tools/systems 104 may include a variety of specialized systems and tools that are used across the different stages of the SDLC, such as those relating to software planning, documentation, SCM, deployment, and/or deployment monitoring.

The planning tool/system 104-1 may be used to define project scope, requirements, and objectives. In one or more embodiments, the planning tool/system 104-1 may include project management software that helps with task allocation, progress tracking, and resource management. In some embodiments, the planning tool/system 104-1 may also facilitate collaboration among team members through features such as shared calendars, task lists, and/or communication platforms.

The documentation tool/system 104-2 may be used to create, manage, and store project documentation. In one or more embodiments, the documentation tool/system 104-2 may include word processors or other documentation platforms that allow for the creation of design documents, user manuals, and/or technical specifications. In some embodiments, the documentation tool/system 104-2 may support version control and collaborative editing, enabling multiple team members to contribute to and update documentation in real-time or near real-time.

The SCM and/or CI tool/system 104-3 may be used to manage source code, track code changes that are made by different developers, and manage builds using the source code. In one or more embodiments, the SCM and/or CI tool/system 104-3 may include repositories that provide functionalities such as version control, branching, and/or merging. In software development, a main codebase represents the primary repository of source code for an application. Application features are often developed in separate branches of the codebase, with each branch containing the source code specific to a particular feature. Once the development and testing of a feature are complete, the branch may be merged into the main codebase so as to integrate the new feature with the existing code. This process ensures that the main codebase remains stable and up-to-date with the latest features and improvements.

The CD tool/system 104-4 may be used to automate the deployment of software applications to various environments. In one or more embodiments, the deployment tool/system 104-4 may include platforms that enable automated building, testing, and deployment of code. In some embodiments, the CD tool/system 104-4 may support rollback mechanisms and deployment pipelines for ensuring smooth and reliable releases.

The environment 104-5 may include one or more runtime environments where software applications may be deployed and executed. In one or more embodiments, the environment 104-5 may include isolated settings for running the deployed software, utilizing technologies such as containers, virtualized instances, or other forms of application isolation to ensure consistent and efficient operation. In some embodiments, the environment 104-5 may be hosted on cloud platforms, offering scalability and flexibility for operation and management.

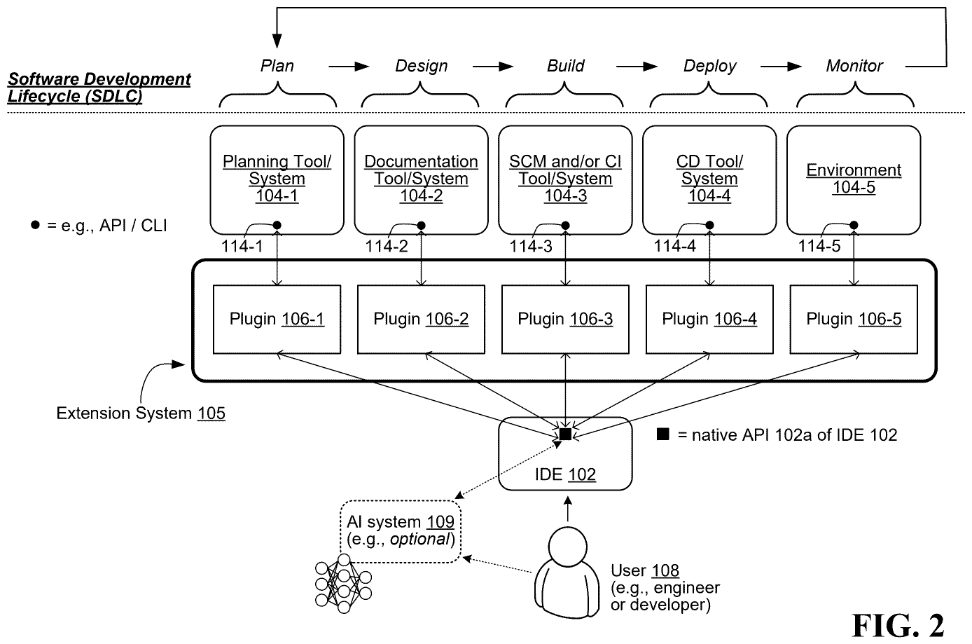

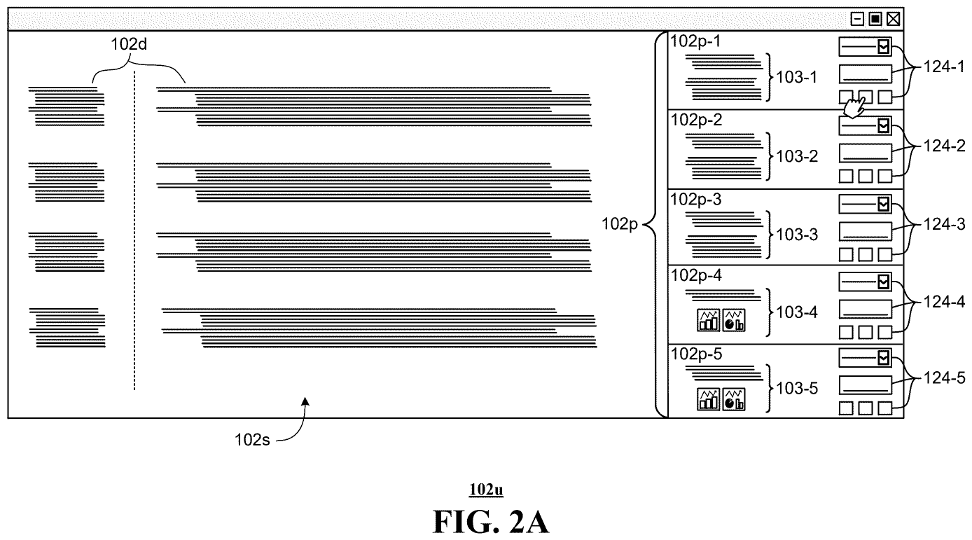

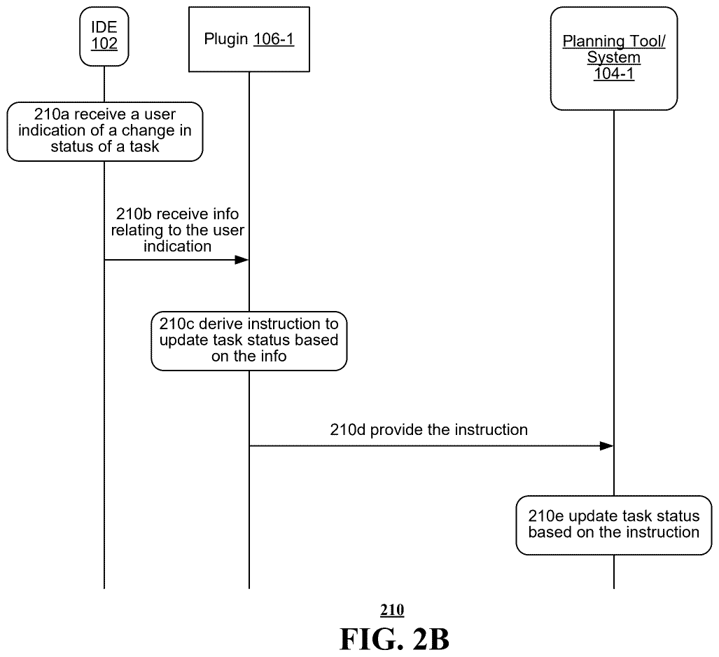

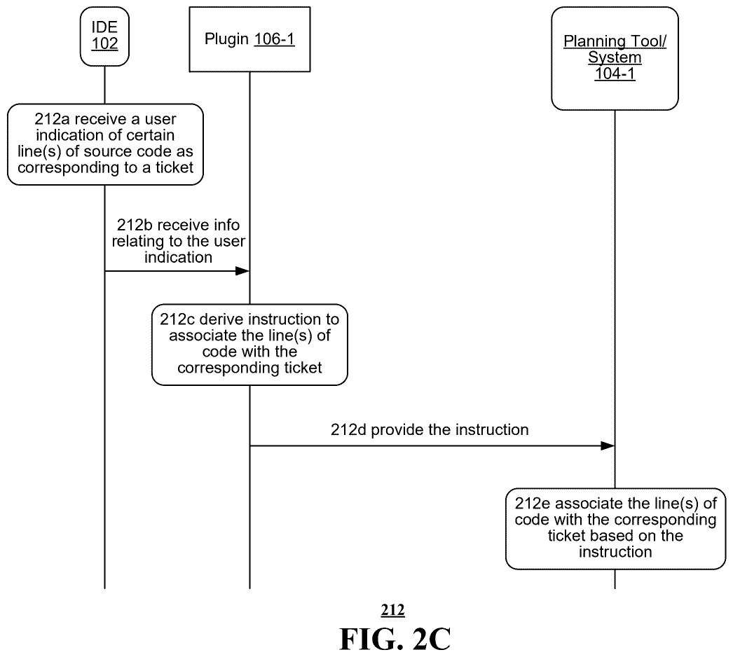

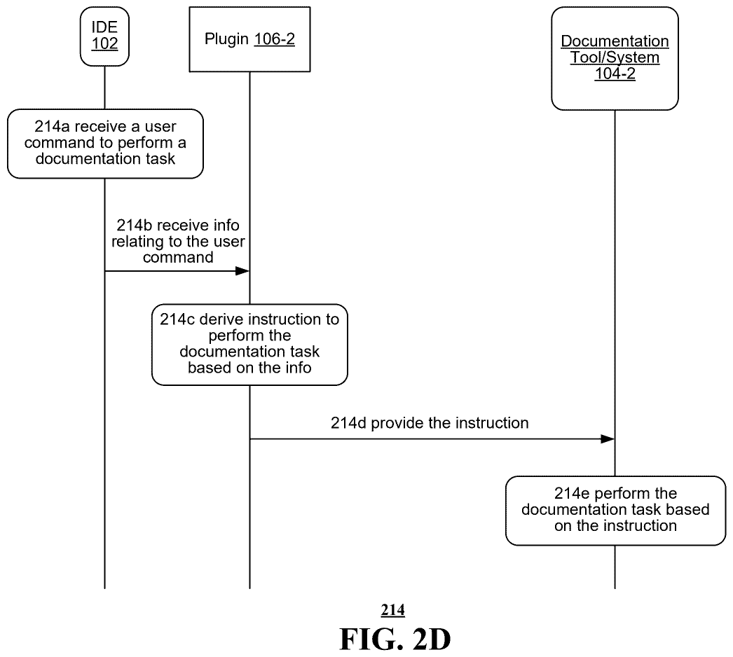

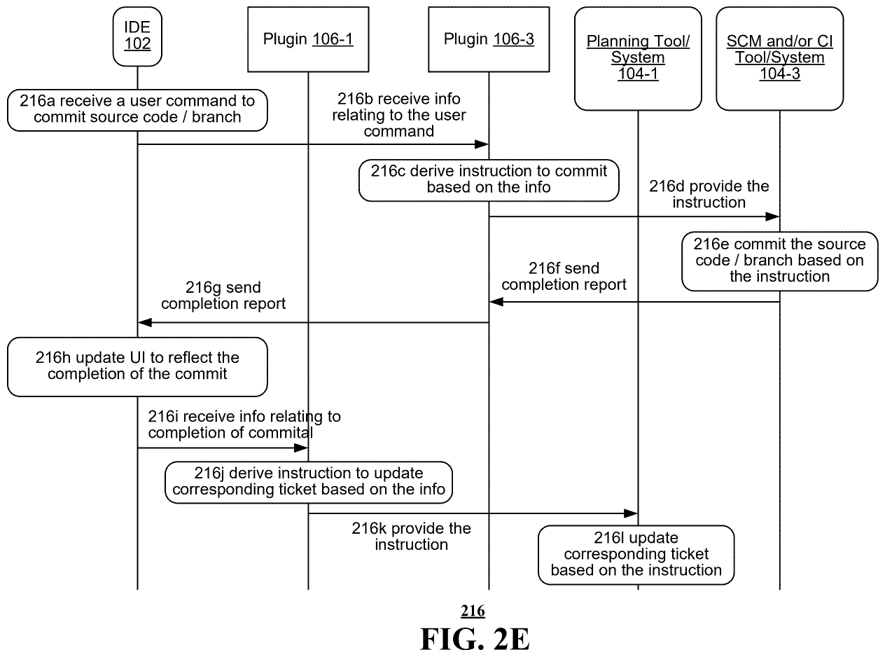

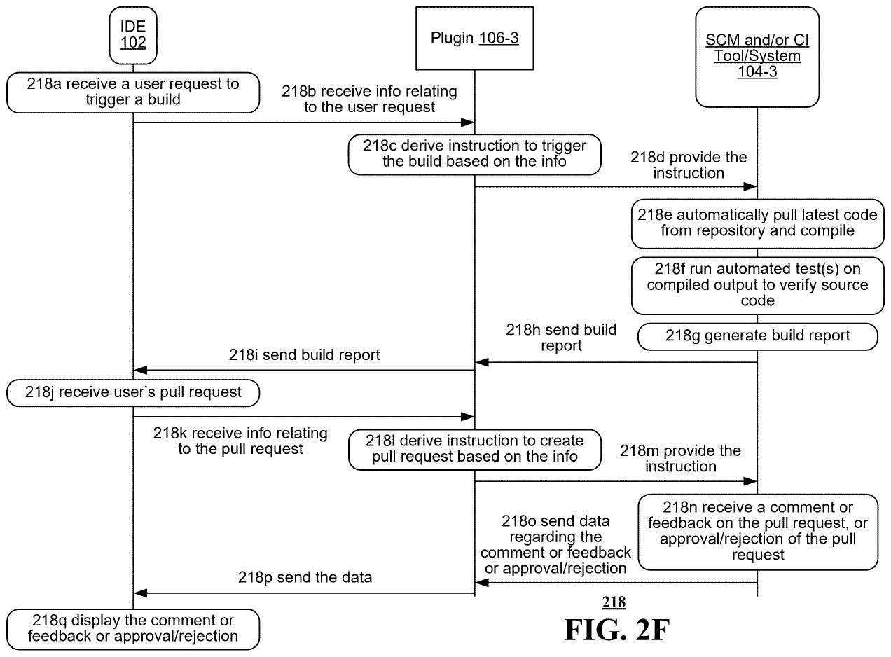

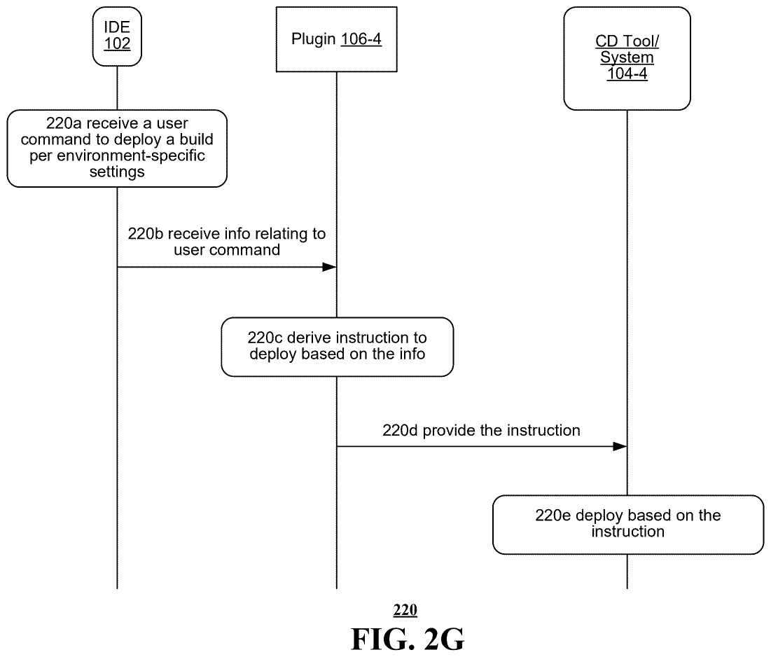

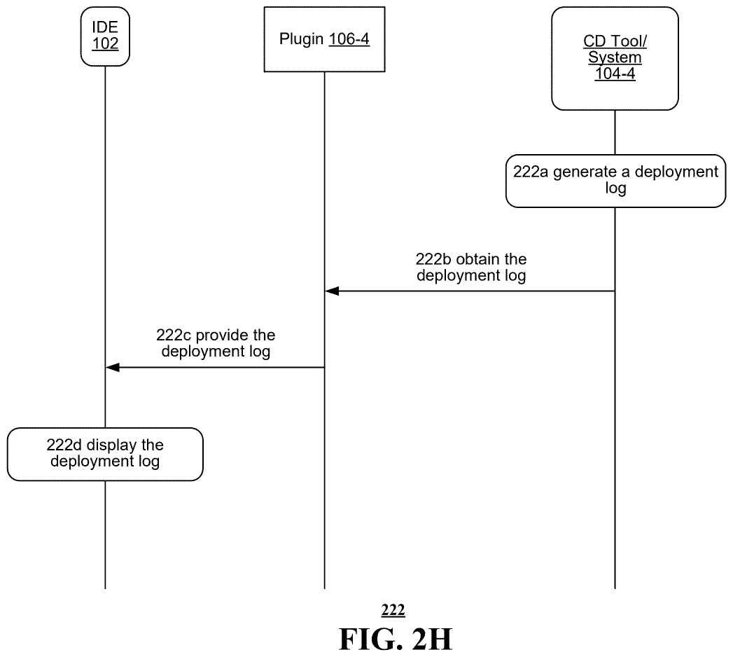

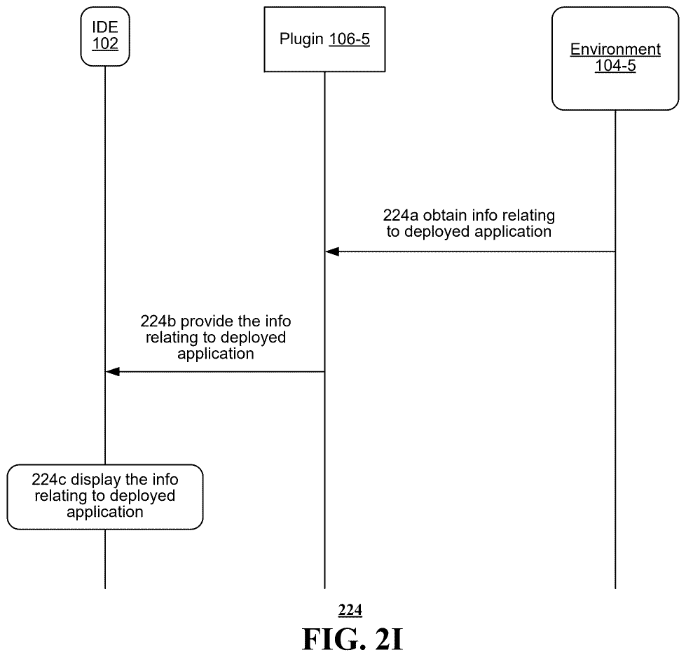

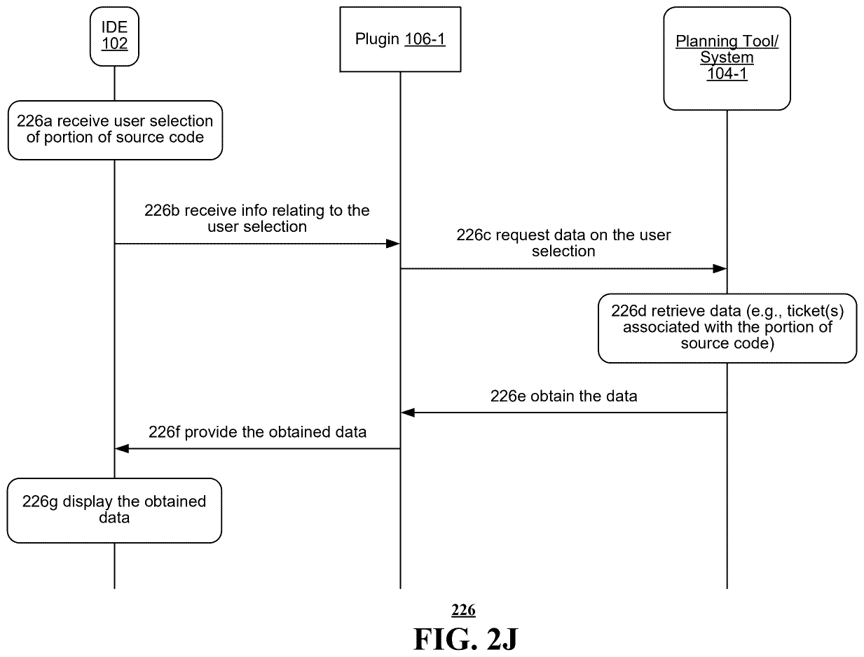

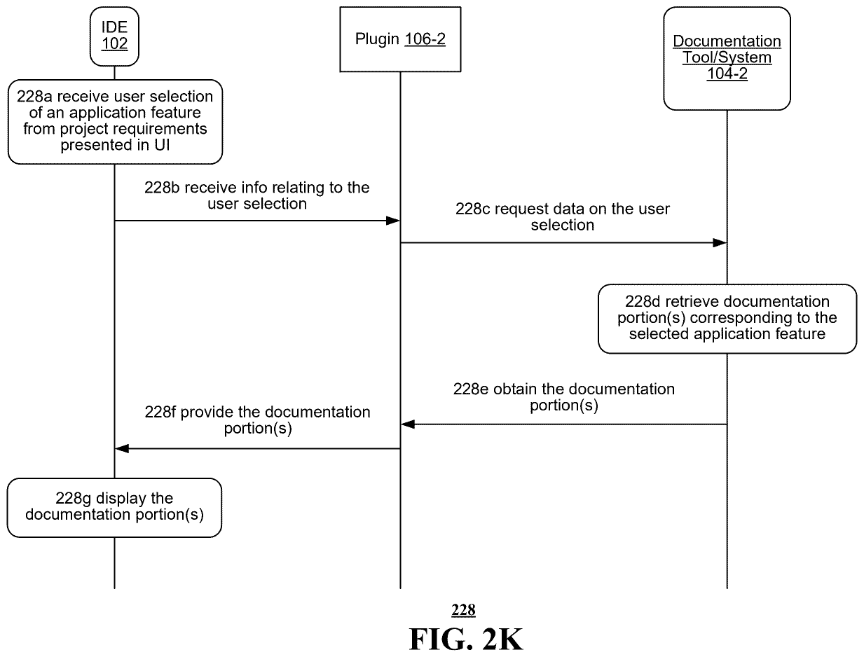

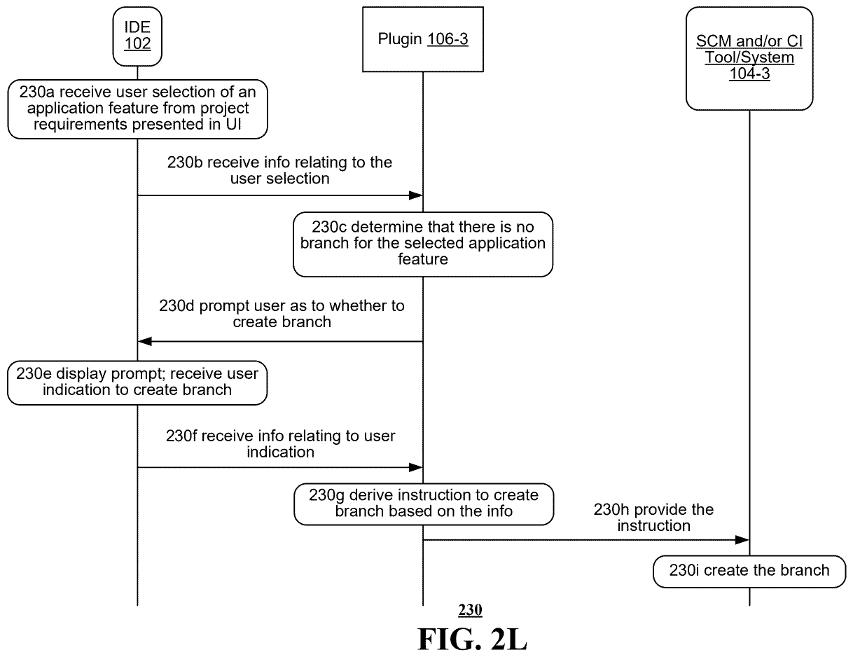

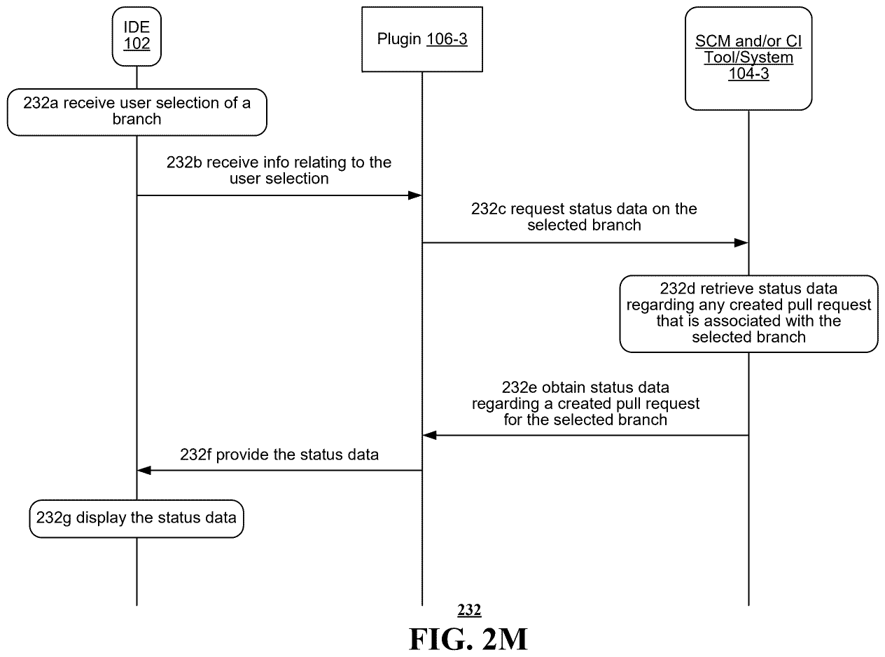

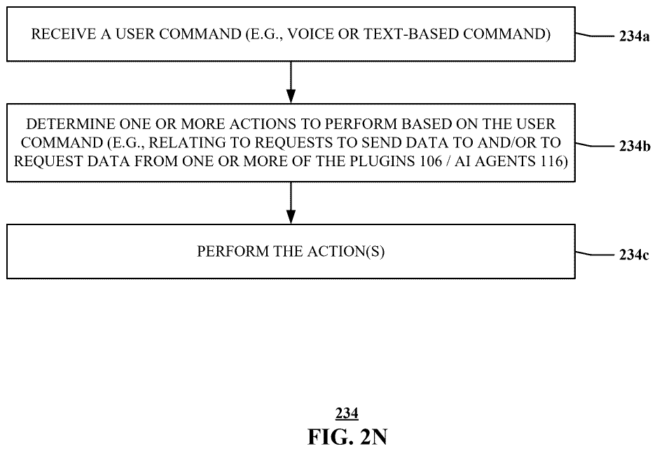

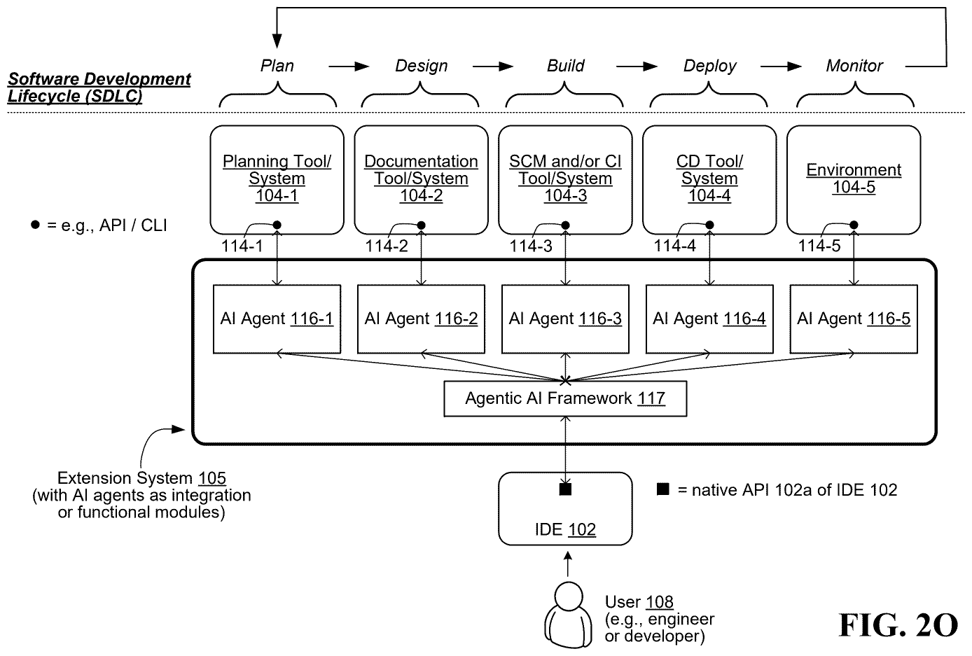

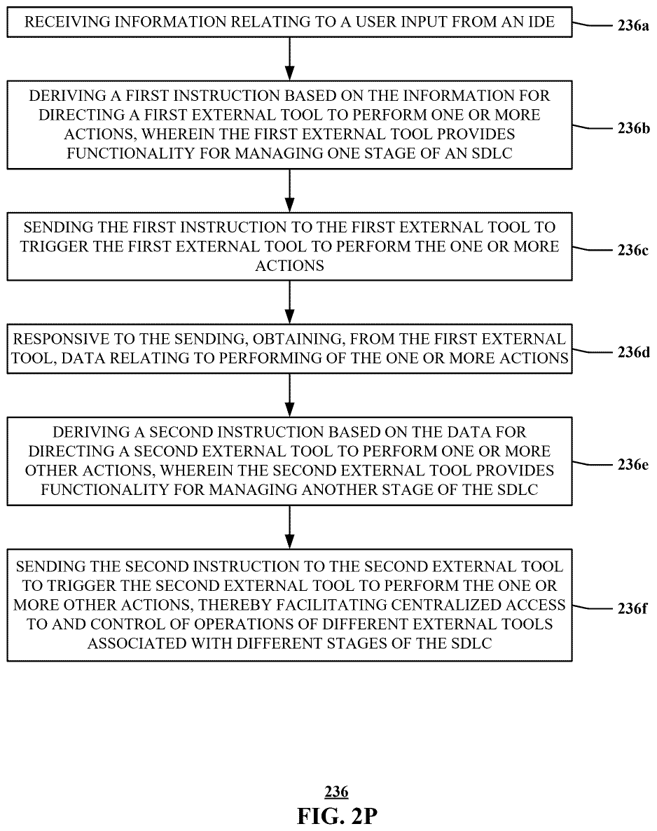

The environment 100 may also include an extension system 105 that is configured to interface the IDE 102 with the various tools/systems 104. The extension system 105 may include one or more integration (or functional) modules. As illustrated in FIG. 1, the extension system 105 may include one or more plugins 106-1 through 106-P (P≥1) (hereinafter referred to collectively as “plugins 106,” and individually as “plugin 106” or by specific designation [e.g., plugins 106-1, 106-2, 106-3, etc.]). In certain embodiments, the integration (or functional) modules of the extension system 105 may additionally, or alternatively, be AI agents 116-1 through 116-P (hereinafter referred to collectively as “AI agents 116,” and individually as “AI agent 116” or by specific designation [e.g., AI agents 116-1, 116-2, 116-3, etc.]) that are integrated in an agentic AI framework. These embodiments are discussed in more detail below with respect to FIG. 2O.

While FIG. 1 illustrates the IDE 102 as being directly coupled to the plugins 106 and the plugins 106 as being directly coupled to the tools/systems 104, one or more wired and/or wireless connections may alternatively be provided to facilitate communicative coupling between the IDE 102 and the plugins 106 and/or between the plugins 106 and the tools/systems 104.

The extension system 105 may be a modular framework that is designed to facilitate integration between the IDE 102 and the (e.g., individual) tools/systems 104. This implementation approach allows for flexible customization and extension of the IDE 102's capabilities. Referring to FIG. 2, the plugins 106 of the extension system 105 may function as separate modules that integrate with the IDE 102 via a native API 102a of the IDE 102. The API 102a may enable the plugins 106 to interact with a UI of the IDE 102 (e.g., a UI 102u illustrated in FIG. 2A and described in more detail below), access the IDE 102's code editor, respond to actions (e.g., from a user 108) with respect to the IDE 102, and so on. The plugins 106 may interface the IDE 102 with corresponding tools/systems 104-1 through 104-5 via respective APIs/CLIs 114-1 through 114-5 thereof. Particularly, the plugin 106-1 may interface the IDE 102 with the planning tool/system 104-1, the plugin 106-2 may interface the IDE 102 with the documentation tool/system 104-2, the plugin 106-3 may interface the IDE 102 with the SCM and/or CI tool/system 104-3, the plugin 106-4 may interface the IDE 102 with the CD tool/system 104-4, and the plugin 106-5 may interface the IDE 102 with the environment 104-5.

In exemplary embodiments, the plugins 106 may be implemented as event-driven components. The plugins 106 may be capable of leveraging the native API 102a of the IDE 102 to facilitate the flow of actions relating to the various tools/systems 104. In this way, the IDE 102 may act as the central hub that channels data flow between the plugins 106. The plugins 106 may listen or detect for specific events that are triggered within the IDE 102 (such as via user inputs to the UI 102u of the IDE 102) or the corresponding tools/systems 104. Upon detecting an event, a plugin 106 may perform its designated task and trigger subsequent events that other plugins 106 or the IDE 102 may listen or detect for and act upon. For instance, as will be apparent from at least some of the call flows described below with respect to FIGS. 2B to 2M, the plugins 106 may utilize the native API 102a of the IDE 102 to interact with the UI 102u, access the code editor, and/or respond to user actions by communicating with the various tools/systems 104, obtaining data therefrom, and providing the data to the IDE 102 for display in corresponding portions of the UI 102u. Although possibly more prone to errors, in certain embodiments, the plugins 106 may alternatively be communicatively coupled to one another such that the plugins 106 have direct access to each other's functionalities.

In various embodiments, the extension system 105 may be implemented based on available endpoints, required authentication methods, and/or data formats that are needed to interact with the various tools/systems 104. The plugins 106 may handle authentication (e.g., using open authentication (OAuth) or API tokens) to securely interact with the tool/systems 104. Once authenticated, the plugins 106 may make hypertext transfer protocol (HTTP) requests to API endpoints of these tools/systems 104 to fetch and/or send data. For example, the plugin 106-1 may send a GET request to an API endpoint of the planning tool/system 104-1 to retrieve issue details, or may send a POST request to the API endpoint of the planning tool/system 104-1 to update task statuses. Fetched data may be displayed within the UI 102u of the IDE 102, allowing developers to view the current state of their tasks without leaving their coding environment. By way of the functionality of the plugins 106, therefore, any aspect of any stage of an SDLC, from planning to monitoring, may be accessible to the user via the IDE 102.

Referring to FIG. 2A, a UI 102u of the IDE 102 may include a user interactive portion 102s for presenting data 102d relating to native functionality of the IDE 102, such as a code editor, debugger, and/or other development tools. The UI 102u may also include a portion 102p that is configured to display data relating to the various tools/systems 104. The portion 102p may be further divided into sub-portions. A portion 102p-1 may display data 103-1 relating to the planning tool/system 104-1 (e.g., project scope, task statuses, user assignments, etc.). A portion 102p-2 may display data 103-2 relating to the documentation tool/system 104-2 (e.g., document content, metadata, version history, etc.). A portion 102p-3 may display data 103-3 relating to the SCM and/or CI tool/system 104-3 (e.g., commit history, build status, code changes, etc.). A portion 102p-4 may display data 103-4 relating to the CD tool/system 104-4 (e.g., deployment logs, pipeline configurations, approval statuses, etc.). A portion 102p-5 may display data 103-5 relating to the environment 104-5 (e.g., resource usage, container statuses, performance metrics, etc.). The UI 102u may also include user controls, such as selectable options/buttons and/or input fields, in one or more of the portions 102p-1 through 102p-5 that allow for user interactions with the corresponding tool/systems 104. The portion 102p-1 may include options, input fields, and/or buttons 124-1 for updating task statuses, adding comments to project management tasks, and/or the like. The portion 102p-2 may include options, input fields, and/or buttons 124-2 for creating, editing, and/or saving documentation, adding metadata, such as titles, tags, and version information, and/or the like. The portion 102p-3 may include options, input fields, and/or buttons 124-3 for committing code changes, triggering builds, and/or the like. The portion 102p-4 may include options, input fields, and/or buttons 124-4 for triggering deployments, configuring deployment pipelines, setting approvals, managing rollbacks, and/or the like. The portion 102p-5 may include options, input fields, and/or buttons 124-5 for controlling deployment resources, such as scaling up or down the number of containers, restarting containers or other application isolation resources, and/or the like. These user controls enable developers to interact with the various tools/systems 104 directly from the IDE 102, which enhances productivity and efficiency. In this way, the UI 102u may provide a comprehensive dashboard that allows developers to interact with the various tools/systems 104 directly from the IDE 102.

Several example call flows are described below with respect to FIGS. 2B to 2M. It is to be understood and appreciated that these are merely examples of how the plugins 106 may facilitate integration and interaction between the IDE 102 and the various tools/systems 104 that are used across different stages of the an SDLC, and thus are not exhaustive. Numerous other interactions between the plugins 106 and corresponding tools/systems 104 are possible.

Referring to FIG. 2B, an example call flow 210 for updating task status in the planning tool/system 104-1 is illustrated.

At 210a, the IDE 102 may receive a user indication of a change in status of a task (e.g., completion of code, partial completion of code, etc.). For example, the user indication may be received via a user input to the UI 102u, such as a selection of a status option from a dropdown menu or an input of a status update in a text field. The user input may, for instance, be made via the use of option(s)/button(s)/field(s) 124-1 in the portion 102p-1 of the UI 102u.

At 210b, the plugin 106-1 may receive information relating to the user indication from the IDE 102. For example, the plugin 106-1 may receive the information over the API 102a of the IDE 102. The information may include details about the task, the new status, and/or any additional comments or metadata provided by the user.

At 210c, the plugin 106-1 may derive an instruction to update the task status based on the information. For example, the plugin 106-1 may derive the instruction by parsing the received information, identifying the new status, and/or formatting the instruction in a manner (e.g., by converting the information into a structured format) that the planning tool/system 104-1 can understand and execute to update the status of the task.

At 210d, the plugin 106-1 may provide the instruction to the planning tool/system 104-1. For example, the plugin 106-1 may send the instruction via an API request or command to the planning tool/system 104-1.

At 210e, the planning tool/system 104-1 may update the task status based on the instruction. For example, the planning tool/system 104-1 may update a corresponding task record in a database.

Referring to FIG. 2C, an example call flow 212 for associating code with a ticket in the planning tool/system 104-1 is illustrated.

At 212a, the IDE 102 may receive a user indication of certain lines of source code as corresponding to a ticket in the planning tool/system 104-1. For example, the user indication may be received via a user input to the UI 102u, such as highlighting of line(s) of source code in the portion 102s and selection of an option (e.g., option(s)/button(s) 124-1 in the portion 102p-1 of the UI 102u) to associate those line(s) of source code with a ticket.

At 212b, the plugin 106-1 may receive information relating to the user indication from the IDE 102. For example, the plugin 106-1 may receive the information over the API 102a of the IDE 102. The information may include details about the line(s) of source code, a ticket identifier, and/or any additional comments or metadata that may be provided by the user.

At 212c, the plugin 106-1 may derive an instruction to associate the line(s) of source code with the corresponding ticket based on the information. For example, the plugin 106-1 may derive the instruction by parsing the received information, identifying the line(s) of source code and the ticket, and/or formatting the instruction in a manner (e.g., by converting the information into a structured format) that the planning tool/system 104-1 can understand and execute to associate the line(s) of source code with the ticket.

At 212d, the plugin 106-1 may provide the instruction to the planning tool/system 104-1. For example, the plugin 106-1 may send the instruction via an API request or command to the planning tool/system 104-1.

At 212e, the planning tool/system 104-1 may associate the line(s) of source code with the corresponding ticket based on the instruction. For example, the planning tool/system 104-1 may update a ticket record in a database with the associated line(s) of source code or with line number(s) that correspond to that portion of source code.

Referring to FIG. 2D, an example call flow 214 for managing project documentation is illustrated.

At 214a, the IDE 102 may receive a user command to perform a documentation task, such as to create, update, and/or store project documentation. For example, the user command may be received via a user input to the UI 102u, such as a selection of one or more options (e.g., option(s)/button(s)/field(s) 124-2 in the portion 102p-2) to create a new document, edit an existing document, and/or save changes to a document. The IDE 102 may be configured with a document processor that, when presented in the portion 102p-2 of the UI 102u, allows a user to input, edit, and/or format text as well as add metadata such as titles, tags, version information, etc.

At 214b, the plugin 106-2 may receive information relating to the user command from the IDE 102. For example, the plugin 106-2 may receive the information over the API 102a of the IDE 102. The information may include details about the documentation task, such as the document identifier, the type of action (create, edit, save, etc.), and/or any content or metadata associated with the document.

At 214c, the plugin 106-2 may derive an instruction to perform the documentation task based on the information. For example, the plugin 106-2 may derive the instruction by parsing the received command, identifying the type of action required, and/or formatting the instruction in a manner (e.g., by converting the information into a structured format) that the documentation tool/system 104-2 can understand and execute to perform the requested documentation task.

At 214d, the plugin 106-2 may provide the instruction to the documentation tool/system 104-2. For example, the plugin 106-2 may send the instruction via an API request or command to the documentation tool/system 104-2.

At 214e, the documentation tool/system 104-2 may perform the documentation task based on the instruction. For example, the documentation tool/system 104-2 may create a new document, update an existing document, and/or store changes to a document in a database.

Referring to FIG. 2E, an example call flow 216 for committing code to the SCM tool/system 104-3 and updating the planning tool/system 104-1 is illustrated.

In software development, to commit a piece of source code means to save and record changes made to the code in a version control system, such as an SCM system/tool 104-3, in preparation for the source code to be shared with others or deployed to a production environment. This allows developers to track changes and history, collaborate with others on the same codebase, and roll back to previous versions if needed. A commit may include the changed source code files, a commit message (e.g., a brief description of the changes), a unique identifier (e.g., a commit hash), a timestamp, and/or author information.

At 216a, the IDE 102 may receive a user command to commit source code or a branch of source code. For example, the user command may be received via a user input to the UI 102u, such as highlighting of lines of source code in the portion 102s or a selection of a branch of source code, and a selection of an option to commit the source code or branch of source code from a context menu or selection of a button presented in the UI 102u. The user input to the UI 102u may, for instance, be made via the use of option(s)/button(s)/field(s) 124-3 in the portion 102p-3 of the UI 102u. In one or more embodiments, the user may provide the user input in response to a prompt (e.g., an automatic prompt requesting whether the user wishes to commit selected source code or a selected branch of source code) that is output by the plugin 106-3 to the IDE 102 and presented by the IDE 102 in the portion 102p-3 of the UI 102u. For instance, the plugin 106-3 may detect a user selection of the source code or the branch of source code, and may output the prompt based on such a detection.

At 216b, the plugin 106-3 may receive information relating to the user command from the IDE 102. For example, the plugin 106-3 may receive the information over the API 102a of the IDE 102. The information may include details about source code changes or the branch of source code, such as the files modified, the lines of source code added or removed, and/or a commit message provided by the user.

At 216c, the plugin 106-3 may derive an instruction to commit the source code or branch of source code based on the information. For example, the plugin 106-3 may derive the instruction by parsing the received information, identifying source code changes or the branch of source code, and/or formatting the instruction in a manner (e.g., by converting the commit details into a structured format) that the SCM tool/system 104-3 can understand and execute to commit the source code.

At 216d, the plugin 106-3 may provide the instruction to the SCM tool/system 104-3. For example, the plugin 106-3 may send the instruction via an API request or command to the SCM tool/system 104-3.

At 216e, the SCM tool/system 104-3 may commit the source code or branch of source code based on the instruction. For example, the SCM tool/system 104-3 may update a source code repository with the new source code changes, and may generate a unique commit identifier (e.g., a commit hash).

At 216f, the SCM tool/system 104-3 may report the completion of committal of the source code or branch of source code to the plugin 106-3. For example, the SCM tool/system 104-3 may send a confirmation message to the plugin 106-3 that includes the commit identifier and/or a notification indicating that the commit was successful.

At 216g, the plugin 106-3 may send the completion report to the IDE 102. For example, the plugin 106-3 may send the confirmation message via an API request or command to the IDE 102.

At 216h, the IDE 102 may update the UI 102u to reflect the completion of committal of the source code or branch of source code. For example, the IDE 102 may display a notification and/or update the status of a corresponding task in the portion 102p-3 of the UI 102u to indicate that the source code or branch of source code has been successfully committed.

At 216i, the plugin 106-1 may receive information relating to the completion of committal of the source code or branch of source code from the IDE 102. For example, the plugin 106-1 may receive the information over the API 102a of the IDE 102. The information may include details such as a ticket identifier, the commit identifier, and/or a comment or status update indicating that the source code or branch of source code has been committed. In one or more embodiments, the IDE 102 may send the information to the plugin 106-1 based on the displaying of the notification and/or the update.

At 216j, the plugin 106-1 may derive an instruction to update a corresponding ticket in the planning tool/system 104-1 based on the information. For example, the plugin 106-1 may derive the instruction by parsing the received information, identifying the corresponding ticket, and formatting the instruction in a manner (e.g., by converting the information into a structured format) that the planning tool/system 104-1 can understand and execute to update the ticket.

At 216k, the plugin 106-1 may provide the instruction to the planning tool/system 104-1. For example, the plugin 106-1 may send the instruction via an API request or command to the planning tool/system 104-1.

At 216l, the planning tool/system 104-1 may update the corresponding ticket based on the instruction. For example, the planning tool/system 104-1 may update a ticket record in a database to include the commit identifier and the status update.

Referring to FIG. 2F, an example call flow 218 for triggering a build and handling a pull request is illustrated.

In software development, triggering a build is typically performed by a CI tool/system to compile and test particular source code changes. When a build is triggered, the CI tool/system pulls the latest source code from the source code repository, compiles it, and runs automated tests to verify the integrity of the source code. The build is typically created based on details, such as the chosen branch and/or any build parameters specified by the developer.

A pull request is a feature commonly used in an SCM tool/system to notify team members that a developer has completed a piece of work and is requesting that it be reviewed and merged into the main codebase. This process is essential for collaborative software development, as it facilitates source code review, discussion, and quality assurance before changes are integrated into the main codebase. A pull request typically includes details about the changes, such as the branch involved, the files modified, the lines of source code added or removed, and/or any relevant comments or descriptions. Team members can review the pull request, leave comments, suggest improvements, and approve or request changes.

At 218a, the IDE 102 may receive a user request to trigger a build. For example, the user request may be received via a user input to the UI 102u, such as a selection of an option to trigger a build from a context menu or a clicking of a build button presented in the UI 102u. The user input may, for instance, be made via the use of option(s)/button(s)/field(s) 124-3 in the portion 102p-3 of the UI 102u. The user request may identify build details, such as the branch of source code to be built, the commit identifier, the build configuration (e.g., debug or release mode), any environment variables, and/or additional build parameters specified by the user, such as specific test suites to run or deployment targets.

At 218b, the plugin 106-3 may receive information relating to the user request from the IDE 102. For example, the plugin 106-3 may receive the information over the API 102a of the IDE 102. The information may include some or all of the build details.

At 218c, the plugin 106-3 may derive an instruction to trigger the build based on the information. For example, the plugin 106-3 may derive the instruction by parsing the received information, identifying the required build actions, and/or formatting the instruction in a manner (e.g., by converting the build details into a structured format) that the SCM and/or CI tool/system 104-3 can understand and execute to perform the build.

At 218d, the plugin 106-3 may provide the instruction to the SCM and/or CI tool/system 104-3. For example, the plugin 106-3 may send the instruction via an API request or command to the SCM and/or CI tool/system 104-3.

At 218e, the SCM and/or CI tool/system 104-3 may automatically pull the latest source code from the repository and compile it. For example, the SCM and/or CI tool/system 104-3 may fetch the latest source code from the specified branch of source code and initiate a compilation process on the fetched source code.

At 218f, the SCM and/or CI tool/system 104-3 may run automated test(s) to verify that the source code does not have any issues. For example, the SCM and/or CI tool/system 104-3 may execute a suite of automated tests to ensure the integrity of the source code.

At 218g, the SCM and/or CI tool/system 104-3 may generate a build report that includes the status of the build, any errors encountered, and/or the results of the automated test(s). For example, the build report may include details on whether the build was successful, any compilation errors, and/or the outcomes of the automated test(s).

At 218h, the SCM and/or CI tool/system 104-3 may send the build report to the plugin 106-3. For example, the SCM and/or CI tool/system 104-3 may send the build report to the plugin 106-3 via an API response or data transfer.

At 218i, the plugin 106-3 may send the build report to the IDE 102. For example, the plugin 106-3 may send the build report to the IDE 102 via an API request or command to the IDE 102.

At 218j, in a case where the build is successful, a user may submit a pull request in the IDE 102. For example, the user may initiate a pull request via the UI 102u, such as by selecting an option to create a pull request from a context menu or clicking a pull request button presented in the UI 102u (e.g., via the use of option(s)/button(s)/field(s) 124-3 in the portion 102p-3 of the UI 102u). In one or more embodiments, the user may provide the user input in response to a prompt (e.g., an automatic prompt requesting whether the user wishes to create a pull request) that is output by the plugin 106-3 to the IDE 102 and presented by the IDE 102 in the portion 102p-3 of the UI 102u. For instance, the plugin 106-3 may detect the successful build over the API of the CI tool/system 104-3, and may output the prompt based on such a detection.

At 218k, the plugin 106-3 may receive information relating to the pull request. For example, the plugin 106-3 may receive the information over the API 102a of the IDE 102. The information may include details about the pull request, such as the branch of source code, commit identifier, and/or any comments or descriptions provided by the user.

At 218l, the plugin 106-3 may derive an instruction to create the pull request based on the information. For example, the plugin 106-3 may derive the instruction by parsing the received information, identifying the required actions, and/or formatting the instruction in a manner (e.g., by converting the pull request details into a structured format) that the SCM tool/system 104-3 can understand and execute to create the pull request.

At 218m, the plugin 106-3 may provide the instruction to the SCM tool/system 104-3. For example, the plugin 106-3 may send the instruction via an API request or command to the SCM tool/system 104-3. In one or more embodiments, the plugin 106-3 may alternatively trigger creation of pull requests independent of whether a user request is detected. In these embodiments, the plugin 106-3 may instead detect a successful build over the API of the CI tool/system 104-3, and may, based on such a detection, send an instruction to the SCM tool 104-3 to create the pull request.

At 218n, the SCM tool/system 104-3 may, after creation of the pull request, receive a comment or feedback on the pull request or approval/rejection of the pull request. For example, team members may review the pull request and leave comments or feedback or approval/reject the pull request via a UI of the SCM tool/system 104-3.

At 218o, the SCM tool/system 104-3 may send data relating to the comment or feedback or approval/rejection to the plugin 106-3. For example, the SCM tool/system 104-3 may send the comment or feedback or the approval/rejection to the plugin 106-3 via an API request or data transfer. In some embodiments, the plugin 106-3 may subscribe to the pull request in the SCM tool/system 104-3. In these embodiments, the SCM tool/system 104-3 may generate the data based upon receiving the comment or feedback or approval/rejection, and may push the data to the plugin 106-3.

At 218p, the plugin 106-3 may send the data to the IDE 102. For example, the plugin 106-3 may send the data to the IDE 102 via an API request or data transfer.

At 218q, the IDE 102 may display the comment or feedback or an indication of the approval/rejection within the IDE 102 (e.g., in the portion 102p-3 of the UI 102u). For example, the IDE 102 may display the comment or feedback or the indication of the approval/rejection in a readable format, such as in the form of text or images, allowing the user to view and ascertain the response to the pull request from directly within the IDE 102. Although not illustrated in FIG. 2F, in a scenario where a comment or feedback is received, the user may provide a response to the comment or feedback (e.g., by using option(s)/button(s)/field(s) 124-3 in the portion 102p-3 of the UI 102u). In this scenario, the plugin 106-3 may communicate the response to the SCM tool/system 104-3. Although also not illustrated in FIG. 2F, in a different scenario where the pull request is approved, the user may choose to merge the source code into a main codebase directly from the IDE 102 (e.g., by using option(s)/button(s)/field(s) 124-3 in the portion 102p-3 of the UI 102u). In this scenario, the plugin 106-3 may communicate the merge request to the SCM tool/system 104-3.

Referring to FIG. 2G, an example call flow 220 for deploying a build to a particular environment is illustrated.

At 220a, the IDE 102 may receive a user command to deploy a build in accordance with environment-specific settings. For example, the user command may be received via a user input to the UI 102u of the IDE 102, such as a selection of an identifier corresponding to a main codebase, an identifier corresponding to a branch from the main codebase, one or more deployment options that set the environment, the target container or virtual instance, deployment approvals, deployment rollbacks, monitoring parameters, and/or the like. The user input may, for instance, be made via the use of option(s)/button(s)/field(s) 124-4 in the portion 102p-4 of the UI 102u.

At 220b, the plugin 106-4 may receive information relating to the user command. For example, the plugin 106-4 may receive the information over the API 102a of the IDE 102. The information may include the selected identifier, the deployment options, etc.

At 220c, the plugin 106-4 may derive an instruction to deploy the build based on the information. For example, the plugin 106-4 may derive the instruction by parsing the received information, identifying the required actions, and/or formatting the instruction in a manner (e.g., by converting the environment-specific settings into a structured format) that the CD tool/system 104-4 can understand and execute to deploy the build based on the settings.

At 220d, the plugin 106-4 may provide the instruction to the CD tool/system 104-4. For example, the plugin 106-4 may send the instruction via an API request or command to the CD tool/system 104-4.

At 220e, the CD tool/system 104-4 may deploy the build in accordance with the environment-specific settings based on the instruction.

Referring to FIG. 2H, an example call flow 222 for obtaining and displaying a deployment log is illustrated.

At 222a, the CD tool/system 104-4 may generate a log relating to deployment of a build. As an example, the deployment log may include details about the deployment process, such as the status of the deployment, any errors encountered, and/or performance metrics. In various embodiments, the CD tool/system 104-4 may be configured to generate the deployment log based on one or more conditions being satisfied (e.g., periodically, deployment failure, deployment success, user request submitted via the UI 102u that is forwarded by the plugin 106-4 to the CD tool/system 104-4 via an API request or command, and/or the like).

At 222b, the plugin 106-4 may obtain the deployment log from the CD tool/system 104-4. For example, in a case where the plugin 106-4 requests the deployment log via an API request to the CD tool/system 104-4, the plugin 106-4 may obtain the deployment log via an API response from the CD tool/system 104-4. As another example, the plugin 106-4 may subscribe to deployment logs in the CD tool/system 104-4, in which case the CD tool/system 104-4 may generate the deployment log based upon the abovementioned one or more conditions being satisfied, and may push the generated deployment log to the plugin 106-4.

At 222c, the plugin 106-4 may provide the deployment log to the IDE 102. For example, in a case where a user request for deployment information was submitted via the UI 102u and detected by the plugin 106-4 over the API 102a of the IDE 102, the plugin 106-4 may send the deployment log to the IDE 102 as a response to the detected request. As another example, the plugin 106-4 may provide the deployment log to the IDE 102 in one or more data streams regardless of whether a request therefor is made.

At 222d, the IDE 102 may present the deployment log in the UI 102u (e.g., in the portion 102p-4 of the UI 102u). The IDE 102 may display the deployment log in a user-readable format, such as in the form of text, images, charts, graphs, and/or the like, allowing the user to troubleshoot or audit the deployment.

Referring to FIG. 2I, an example call flow 224 for monitoring a deployed application is illustrated.

At 224a, the plugin 106-5 may obtain (e.g., real-time or near real-time) information relating to the deployed application from the environment 104-5. For example, the plugin 106-5 may obtain the information by making API request(s) to monitoring endpoints exposed by the environment 104-5 or by subscribing to data stream(s) provided by the environment 104-5. The information may identify, for instance, resources (e.g., container, virtual instance, etc.) used, central processing unit (CPU) usage, memory usage, response times, and/or error rates from the environment 104-5 to assess the application's performance and health.

At 224b, the plugin 106-5 may send the obtained information to the IDE 102. For example, in a case where a user request for monitoring data was submitted via the UI 102u and detected by the plugin 106-5 over the API 102a of the IDE 102, the plugin 106-5 may send the information to the IDE 102 as a response to the detected request. As another example, the plugin 106-5 may provide the information to the IDE 102 in one or more data streams regardless of whether a request therefor is made.

At 224c, the IDE 102 may present the information (e.g., in the portion 102p-5 of the UI 102u). For example, the IDE 102 may display the information in a readable format, such as in the form of text, images, charts, graphs, and/or the like, allowing the user to monitor the overall health or performance of the deployed application.

Referring to FIG. 2J, an example call flow 226 for facilitating identification of project management information based on a user selection of particular source code is illustrated.

At 226a, the IDE 102 may receive a user selection of a portion of source code (e.g., one or more lines of source code). For example, the user selection may be received via a user input to the UI 102u, such as highlighting of line(s) of the source code in the portion 102s of the UI 102u.

At 226b, the plugin 106-1 may receive information relating to the user selection from the IDE 102. For example, the plugin 106-1 may receive the information over the API 102a of the IDE 102. The information may include details about the selected portion of source code, such as the file name and line numbers.

At 226c, the plugin 106-1 may request data on the user selection from the planning tool/system 104-1. For example, the plugin 106-1 may send an API request to the planning tool/system 104-1 for data relating to the selected portion of source code, such as issue ticket(s) associated with the selected line(s) of source code.

At 226d, the planning tool/system 104-1 may retrieve the requested data. For example, the planning tool/system 104-1 may retrieve information about issue ticket(s) relating to the selected portion of source code from a database.

At 226e, the plugin 106-1 may obtain the data from the planning tool/system 104-1. For example, the plugin 106-1 may obtain the data from the planning tool/system 104-1 via an API response.

At 226f, the plugin 106-1 may provide the obtained data to the IDE 102. For example, the plugin 106-1 may send the data to the IDE 102 via an API request or data transfer.

At 226g, the IDE 102 may display the obtained data (e.g., in the portion 102p-1 of the UI 102u). For example, the IDE 102 may present the data in a readable format, allowing the user to review the issue ticket(s) relating to the selected portion of source code.

Although not specifically illustrated in FIG. 2J, the plugin 106-3 may additionally, or alternatively, be capable of facilitating identification of technical review comments or error logs (e.g., received/detected at the SCM or CI tool/system 104-3) based on a user selection of particular source code. The plugin 106-3 may be capable of facilitating such identification in a manner similar to that described above with respect to FIG. 2J.

Referring to FIG. 2K, an example call flow 228 for displaying documentation for a selected application feature is illustrated.

Assume that project requirements for particular application features (e.g., user authentication, chat and messaging, search functionality, etc.) that are to be developed are presented in the portion 102p-1 of the UI 102u. For instance, the plugin 102p-1 may have obtained the project requirements from the planning tool/system 104-1 and provided the project requirements to the IDE 102 for display in the portion 102p-1 of the UI 102u.

At 228a, the IDE 102 may receive a user selection of an application feature (e.g., user authentication) presented in portion 102p-1. For example, the user selection may be received via a user input to the UI 102u, such as a selection of an option or button corresponding to the application feature. The user input to the UI 102u may, for instance, be made via the use of option(s)/button(s)/field(s) 124-1 in the portion 102p-1 of the UI 102u.

At 228b, the plugin 106-2 may receive information relating to the selected application feature from the IDE 102. For example, the plugin 106-2 may receive the information over the API 102a of the IDE 102. The information may include details about the selected application feature, such as a feature identifier and/or any associated metadata.

At 228c, the plugin 106-2 may request data on the user selection from the documentation tool/system 104-2. For example, the plugin 106-2 may send an API request to the documentation tool/system 104-2 that includes the feature identifier and a request for the relevant documentation.

At 228d, the documentation tool/system 104-2 may retrieve the requested documentation portion(s). For example, the documentation tool/system 104-2 may search a database for documentation relating to the selected application feature and may retrieve the relevant portion(s).

At 228e, the plugin 106-2 may obtain the documentation portion(s) from the documentation tool/system 104-2. For example, the plugin 106-2 may obtain the documentation portion(s) from the documentation tool/system 104-2 via an API response.

At 228f, the plugin 106-2 may send the documentation portion(s) to the IDE 102. For example, the plugin 106-2 may send the documentation data to the IDE 102 via an API request or data transfer.

At 228g, the IDE 102 may display the documentation portion(s) (e.g., in the portion 102p-2 of the UI 102u).

Referring to FIG. 2L, an example call flow 230 for creating a branch of source code (or a feature branch) for a selected application feature is illustrated.

Assume that project requirements for particular application features (e.g., user authentication, chat and messaging, search functionality, etc.) that are to be developed are presented in the portion 102p-1 of the UI 102u. For instance, the plugin 106-1 may have obtained the project requirements from the planning tool/system 104-1 and provided the project requirements to the IDE 102 for display in the portion 102p-1 of the UI 102u.

At 230a, the IDE 102 may receive a user selection of an application feature from the project requirements presented in the UI 102u. For example, the user selection may be received via a user input to the UI 102u, such as a selection of an option or button corresponding to the application feature. The user input to the UI 102u may, for instance, be made via the use of option(s)/button(s)/field(s) 124-1 in the portion 102p-1 of the UI 102u.

At 230b, the plugin 106-3 may receive information relating to the selected application feature from the IDE 102. For example, the plugin 106-3 may receive the information over the API 102a of the IDE 102. The information may include details about the selected application feature, such as a feature identifier and/or any associated metadata.

At 230c, the plugin 106-3 may determine that there is no existing feature branch for the selected application feature. For example, the plugin 106-3 may query the SCM tool/system 104-3 to check for an existing feature branch corresponding to the selected application feature, and may receive a response from the SCM tool/system 104-3 that there is no feature branch for such a feature.

At 230d, the plugin 106-3 may instruct the IDE 102 to present a prompt as to whether to create a new feature branch for the selected application feature. For example, the plugin 106-3 may send the instruction to the IDE 102 via an API request or command.

At 230e, the IDE 102 may display the prompt (e.g., in the portion 102p-3 of the UI 102u), and may receive a user response to the prompt to create the source code branch. For example, the user indication may be received via a user input to the UI 102u, such as a selection of an option or button to create the source code branch. The user input to the UI 102u may, for instance, be made via the use of option(s)/button(s)/field(s) 124-3 in the portion 102p-3 of the UI 102u.

At 230f, the plugin 106-3 may receive information relating to the user indication from the IDE 102. For example, the plugin 106-3 may receive the information over the API 102a of the IDE 102 to create the source code branch.

At 230g, the plugin 106-3 may derive an instruction to create the feature branch based on the user indication. For example, the plugin 106-3 may derive the instruction by formatting an instruction in a manner (e.g., by converting the information in a structured format) that the SCM tool/system 104-3 can understand and execute to create the feature branch.

At 230h, the plugin 106-3 may provide the instruction to the SCM tool/system 104-3. For example, the plugin 106-3 may send the instruction via an API request or command to the SCM tool/system 104-3.

At 230i, the SCM tool/system 104-3 may create the feature branch based on the instruction. For example, the SCM tool/system 104-3 may update the source code repository to include the new feature branch corresponding to the selected application feature.

Referring to FIG. 2M, an example call flow 232 for checking if there is a pull request for a selected branch of source code is illustrated.

Assume that information regarding feature branches (e.g., by name or other identifier) for various application features (e.g., user authentication, chat and messaging, search functionality, etc.) is presented in the portion 102p-3 of the UI 102u. For instance, the plugin 106-3 may have obtained the branch information from the SCM tool/system 104-3 and provided the branch information to the IDE 102 for display in the portion 102p-3.

At 232a, the IDE 102 may receive a user selection of a branch of source code from the branches presented in the UI 102u. For example, the user selection may be received via a user input to the UI 102u, such as a selection of an option or button corresponding to the branch of source code. The user input to the UI 102u may, for instance, be made via the use of option(s)/button(s)/field(s) 124-3 in the portion 102p-3 of the UI 102u.

At 232b, the plugin 106-3 may receive information about the selected branch of source code from the IDE 102. For example, the plugin 106-3 may receive the information over the API 102a of the IDE 102. The information may include details about the selected branch of source code, such as a branch identifier and/or any associated metadata.

At 232c, the plugin 106-3 may request status data on the selected branch of source code from the SCM tool/system 104-3. For example, the plugin 106-3 may send an API request to the SCM tool/system 104-3 to obtain status data relating to the selected branch of source code, such as any associated pull requests.

At 232d, the SCM tool/system 104-3 may retrieve the status data regarding any created pull request that is associated with the selected branch of source code. For example, the SCM tool/system 104-3 may search a database for pull requests related to the selected branch of source code, and may retrieve identified pull request(s).

At 232e, the plugin 106-3 may obtain the status data from the SCM tool/system 104-3. For example, the plugin 106-3 may obtain the status data from the SCM tool/system 104-3 via an API response.

At 232f, the plugin 106-3 may send the status data to the IDE 102. For example, the plugin 106-3 may send the data to the IDE 102 via an API request or data transfer.

At 232g, the IDE 102 may display the status data (e.g., in the portion 102p-3 of the UI 102u).

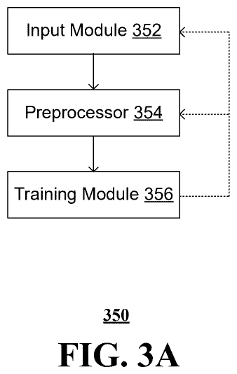

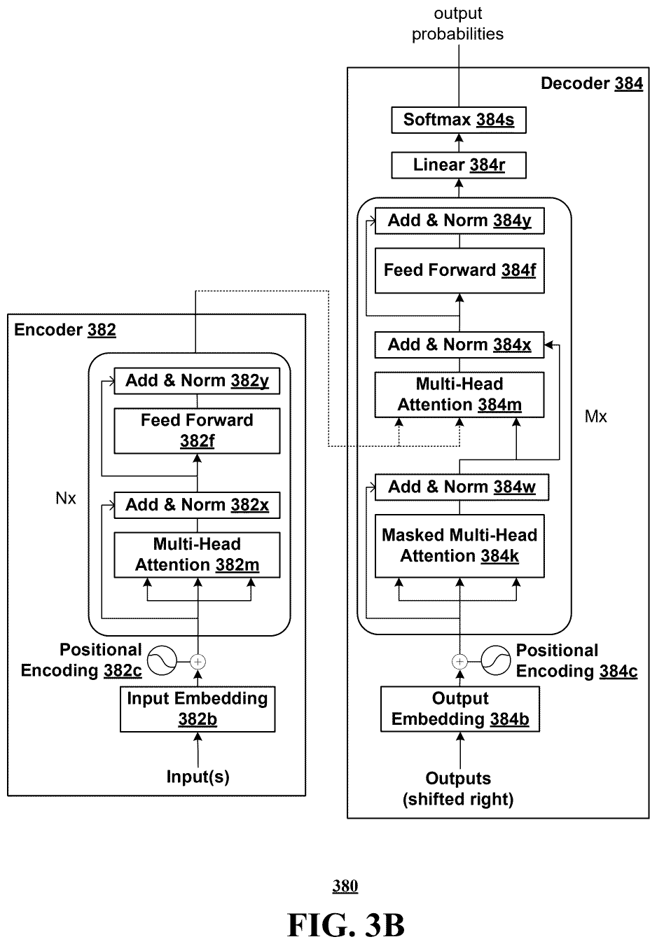

Referring again to FIG. 2, the IDE 102 may optionally be configured with an AI system 109 that functions as a user interface between the user 108 and the IDE 102. In various embodiments, the AI system 109 may be trained via an AI architecture (e.g., an AI architecture 350 illustrated in FIG. 3A and described in more detail below). The AI system 109 may include one or more AI models (e.g., large language model(s) (LLMs), such as an LLM that is based on the transformer model 380 illustrated in FIG. 3B and described in more detail below) that are trained to interpret user commands and manage control of the plugins 106 based on the interpretation.

The AI system 109 may have access to the API 102a of the IDE 102 to reach endpoints of the plugins 106. Referring to FIG. 2N, an example process 234 implemented by the AI system 109 is illustrated.

At 234a, the AI system 109 may receive a user command. For instance, the user command may include a voice or text-based command provided using an input device that is communicatively coupled to the AI system 109.

At 234b, the AI system 109 may determine one or more actions to perform based on the user command. The action(s) may relate to requests to send data to and/or to request data from one or more of the plugins 106.

At 234c, the AI system 109 may perform the action(s). For example, the AI system 109 may send API requests to the identified endpoints of certain plugins 106 and/or manage data flow between the IDE 102 and the plugins 106. These actions may be performed, for instance, to facilitate creation of branches, triggering of builds, raising of pull requests, scanning of logs, identification of errors, and other development-related actions.

In one example, a user may wish to create a feature branch for a specific application feature. The user may prompt the AI system 109 with a (e.g., voice or text-based) command such as, “For this particular application feature, create a branch.” The AI system 109 may interpret the command, and based on its training, interact with the plugin 106-3 (e.g., via API requests and responses) to create the feature branch in the SCM tool/system 104-3. This advantageously eliminates the need for the user to manually trigger the creation of the branch whether indirectly via the UI 102u or directly in the SCM tool/system 104-3. Once the feature branch is created, the AI system 109 may monitor for when the user commits source code to the branch. After detecting a code commit, the AI system 109 may automatically trigger a build by interacting with the CI tool/system 104-3. The AI system 109 may then monitor the build process, and upon a successful build, the AI system 109 may automatically raise a pull request to merge the feature branch into the main codebase. This automation advantageously streamlines the development workflow and reduces the need for user intervention at each step.

In another example, the user may encounter an error in a feature branch and wish to identify the line of source code that is responsible for the error. The user may prompt the AI system 109 with a command such as, “For this particular feature branch, I am getting this error; find the line that is responsible for it.” The AI system 109 may interpret the command, and based on its training, scan the logs, analyze a stack trace (i.e., information regarding active stack frames [or method calls] in source code that are made at a specific point in time when an exception or error occurred), and attempt to identify a specific file and line of source code that is responsible for the error. If identified, the AI system 109 may point out the problematic line of code to the use. This may be done in one of several ways. For instance, in one implementation, the AI system 109 may send an API request to the IDE 102 to highlight the specific line of source code in the code editor. In another implementation, the AI system 109 may trigger a debugger to break at the specific line of source code. For example, the AI system 109 may send an API request to the IDE 102 to set a breakpoint at the line of source code and start a debugging session. The debugger may then pause execution at the highlighted line, allowing the user to inspect the source code and variables at that point. In yet another implementation, the AI system 109 may display an error message in the UI 102u with details about the error and the problematic line of source code. For example, the AI system 109 may send an API request to the IDE 102 to display a popup or inline message next to the highlighted line of source code with an explanation of the error. In any case, the AI system 109 may effectively point out the problematic line of source code to the user, saving the user from manually drilling into the views and logs to find the issue. This approach enhances the debugging process and improves the overall efficiency of the development workflow.

While for purposes of simplicity of explanation, the respective processes are shown and described as a series of blocks in FIG. 2N, it is to be understood and appreciated that the claimed subject matter is not limited by the order of the blocks, as some blocks may occur in different orders and/or concurrently with other blocks from what is depicted and described herein. Moreover, not all blocks would necessarily be required to achieve the desired functionality in all cases.

The following is a description of example training that the AI system 109, and more particularly an LLM, may be subjected to.

The LLM may be trained to understand and interpret natural language commands from users, including variations in phrasing and context. This may be achieved by exposing the LLM to a large dataset of user commands and interactions, allowing it to learn the nuances of human language. The training data may include diverse examples of how users might phrase their requests, such as “create a new feature branch” or “find the line of source code that caused this error.”

The LLM may be trained to map specific user commands to corresponding actions. For example, the LLM may be trained to understand that “create a feature branch” maps to creating a branch in the SCM tool/system 104-3. This may involve creating a mapping between common user commands and the corresponding API calls or actions that need to be performed. The LLM may be trained using supervised learning techniques, where the AI system 109 is provided with pairs of user commands and the correct actions to take.

The LLM may be trained to identify which plugin 106 to interact with based on the user command. For instance, the LLM may be trained to recognize that creating a feature branch involves interacting with plugin 106-3. This may be achieved by training the LLM on a dataset that includes examples of user commands and the corresponding plugins that should be used. The LLM may learn to associate certain keywords or phrases with specific plugins, such as “branch” with plugin 106-3 or “deploy”with plugin 106-4.

The LLM may be trained to formulate the appropriate API requests to send to the identified plugin. This may include understanding the required parameters and data formats for each API request. The LLM may be trained using examples of correctly formatted API requests along with the corresponding user commands. The training process may include validation to ensure that the LLM generates API requests that conform to the expected format and include all necessary parameters.

The LLM may be trained to learn various development scenarios and workflows. For example, the LLM may be trained to understand that, after creating a feature branch, the next steps might involve committing source code, triggering a build, and raising a pull request. This may be achieved by training the LLM on sequences of actions that represent common development workflows. The LLM may learn to recognize patterns and dependencies between actions, allowing it to predict and automate subsequent steps based on the current context.

The LLM may be trained to monitor for specific events and conditions. For instance, the LLM may be trained to detect when a user commits source code and then automatically trigger a build based on that event. This may involve training the LLM to recognize event triggers and respond appropriately. The LLM may be trained using examples of event logs and the corresponding actions that should be taken in response.

The LLM may be trained to handle errors and exceptions. This may include training the LLM to understand common error messages and providing appropriate responses or corrective actions. The LLM may be trained using a dataset of error messages and the corresponding actions that should be taken to resolve such errors. The training process may include validation to ensure that the LLM can accurately identify errors and provide helpful responses or suggestions for resolving the errors.

The LLM may be trained to maintain context across multiple interactions. For example, the LLM may be trained to remember the current feature branch being worked on and applying subsequent commands to that context. This may be achieved by training the LLM on sequences of related commands and interactions, allowing it to learn how to maintain and update context information. The LLM may thus be able to track the current state of the development process and use that information to inform its responses to subsequent commands.

The LLM may be trained to interact with the user 108 through the UI 102u of the IDE 102. This may include displaying prompts, highlighting source code, and/or providing feedback or error messages. The LLM may be trained using examples of user interactions and the corresponding UI updates that should be made. The training process may include validation to ensure that the LLM can accurately generate UI updates and provide helpful feedback to the user.

The LLM may be trained to continuously learn and improve based on user interactions and feedback. This may involve retraining the model periodically with new data and scenarios. The LLM may be trained using a combination of supervised and unsupervised learning techniques, allowing it to learn from both labeled examples and real-world interactions. The training process may include mechanisms for incorporating user feedback and updating the model to improve its performance over time.

As briefly discussed above, in certain embodiments, the integration (or functional) modules of the extension system 105 may include AI agents 116 rather than plugins 106. Referring to FIG. 2O, the extension system 105 may include an individual AI agent 116 for each respective tool/system 104. The AI agents 116 may be integrated with or included in an agentic AI framework 117, and may have some or all of the aspects and/or functionalities of the plugins 106 described above with respect to one or more of FIGS. 2 to 2M. In exemplary embodiments, the AI agents 116 may utilize one or more AI models (e.g., LLMs, small language models (SLMs), or the like) to enhance their functionality, including natural language processing, contextual understanding, and decision-making capabilities. For instance, each AI agent 116 may utilize a respective AI model or multiple AI agents 116 may share one or more AI models.

The agentic AI framework 117 may be implemented as a centralized orchestration layer that coordinates and manages interactions between the AI agents 116, the IDE 102, and the corresponding external tools/systems 104. The agentic AI framework 117 may include one or more software components or modules that are designed to facilitate task allocation, dynamic data aggregation, context-sensitive updates, protocol handling, and/or communication management. Each AI agent 116 may register with the agentic AI framework 117, which oversees their lifecycle by maintaining metadata about their associated tools/systems 104, task queues, API endpoints, and/or any contextual dependencies. To assist with their operations, the AI agents 116 may rely on AI models to process user inputs, such as natural language instructions, IDE option/button selections, etc., and interpret their meaning to determine the appropriate tasks to execute. These AI models may also enable the agents 116 to make context-aware recommendations or perform intelligent analysis of data that is relevant to the SDLC stage. In particular, the AI agents 116 may fetch and aggregate data from their respective tools/systems 104, process and interpret domain-relevant information, and/or automate tasks by generating intelligent recommendations. The agentic AI framework 117 may also coordinate the AI agents 116 to periodically fetch and process information, which can keep engineers updated with the most relevant insights directly within the IDE 102.

The agentic AI framework 117 may communicate with each AI agent 116 via predefined protocols (e.g., Representational State Transfer (REST) APIs or the like) or through standardized interfaces that are specific to the framework. This communication enables the agentic AI framework 117 to distribute tasks, query data, receive status updates, and/or aggregate results from the individual AI agents 116. The agentic AI framework 117 may serve as the central orchestrator that enables efficient routing of updates, consolidates information from multiple AI agents 116, and ensures that actions and insights are relayed seamlessly to the engineer's workspace (e.g., via the IDE 102). In exemplary embodiments, each tool/system 104 may interface with a dedicated AI agent 116, and these AI agents may manage the specific integration and operations that are required for their respective tool/system. For example, the planning tool/system 104-1 may interface with an AI agent 116-1 to coordinate updates for project management tasks, while the documentation tool/system 104-2 may interface with an AI agent 116-2 to fetch and organize documentation updates. When an engineer commits code within the IDE 102, the agentic AI framework 117 may notify an AI agent 116-3 that is responsible for integration with the SCM/CI tool/system 104-3. The AI agent 116-1 may be triggered to update the corresponding project management item in the planning tool/system 104-1, report the status back to the agentic AI framework 117, and coordinate with the AI agent 116-4 to manage the CD tool/system 104-4 to begin deployment tasks. The AI agent 116-4 may trigger builds via deployment tools and notify the IDE 102 with real-time (or near real-time) status updates. If the build fails, the AI agent 116-3, 116-4 associated with the SCM/CI tool/system 104-3 or CD tool/system 104-4 may automatically retrieve logs and share them with the agentic AI framework 117, which may display the logs in the IDE 102 to eliminate the need for engineers to manually monitor external platforms. In another example, upon receiving a comment for a pull request in the SCM/CI tool/system 104-3, the AI agent 116-3 may notify the agentic AI framework 117, which may relay the comment to the IDE 102 for review. The engineer can view and respond to the comment, and trigger workflow tasks that are coordinated by other AI agents as needed, such as, for example, AI agent 116-1 updating planning information or the AI agent 116-4 initiating a deployment. Once the code review is complete, the engineer may seamlessly merge the code directly from within the IDE 102, where the AI agent 116-3 may manage source control changes. In various embodiments, the agentic AI framework 117 may also interact with deployment and runtime platforms via particular tools/systems 104 (e.g., orchestration systems or cloud environments). For instance, an AI agent 116-5 corresponding to the runtime environment 104-5 may alert the agentic AI framework 117 when a deployment is successful or fails. As an example, the AI agent 116-5 may monitor deployment resources, such as container-based environments, detect bottlenecks or utilization changes, and/or relay detailed status information to the IDE 102 through the agentic AI framework 117. This allows engineers to diagnose deployment issues or interact with environment metrics directly from their development workspace.

In various embodiments, the agentic AI framework 117 may include advanced logic for multi-agent coordination, such that actions that are initiated by one AI agent 116 do not conflict with the operations of another. The agentic AI framework 117 may also include features for load balancing, aggregating and prioritizing multi-agent tasks based on urgency or dependency, and/or handling error recovery when issues arise in communication or process execution. In various embodiments, the agentic AI framework 117 may implement intelligent scheduling algorithms to improve or optimize workflow efficiency, such as by batching related tasks, prefetching data to reduce or minimize latency, and/or dynamically invoking AI agents 116 for specific workflows based on the SDLC stage and context. By centralizing these coordination and management functions, the agentic AI framework 117 provides a scalable, extensible, and intelligent backbone for the overall system, and enables seamless communication, task orchestration, and (e.g., real-time) information sharing within the IDE 102 for managing the SDLC.

Exemplary embodiments of the agentic AI framework 117 and AI agents 116 thus provide a centralized orchestrator that unifies and simplifies workflows across the SDLC. The agentic AI framework 117 coordinates task allocation, dynamic data aggregation, status updates, and communication with external tools/systems 104, allowing engineers to manage all SDLC stages from within the IDE 102. By utilizing standardized protocols, such as REST APIs, the agentic AI framework 117 ensures seamless integration with diverse tools and platforms while remaining adaptable to new technologies. Moreover, the agentic AI framework 117 delivers real-time (or near real-time) notifications and actionable insights to engineers in the IDE 102, which reduces or minimizes context switching and enables more streamlined operations. Through intelligent scheduling algorithms, task prioritization, and efficient handling of background processes, the agentic AI framework 117 improves or optimizes workflows, reduces inefficiencies, and enhances development productivity. Exemplary embodiments of the AI agents 116 also automate repetitive workflows, such as updating project management tasks, triggering builds and deployments, or monitoring resources, which reduces the need for manual intervention. In addition, the AI agents 116 can process, analyze, and interpret system-specific data to provide intelligent insights and recommendations to engineers. The modularity and scalability of the AI agents 116 allow for easy expansion of the extension system 105 to incorporate new SDLC stages or tools as development needs evolve. Working in coordination with the agentic AI framework 117, the AI agents 116 enable a unified and intelligent workflow that reduces fragmentation, increases efficiency, and simplifies the SDLC from planning to deployment.

While the extension system 105 has been described above as being implemented in individual plugins 106 or AI agents 116, in certain embodiments, a portion or an entirety of the extension system 105 (e.g., one or more of the above-described functionalities of the plugins 106 or AI agents 116) may instead be built into the IDE 102. For instance, the extension system 105 may be embedded directly within a core codebase of the IDE 102.

While the UI 102u of the IDE 102 has been described above with respect to FIG. 2A as including individual portions 102p-1 through 102p-5 for presenting data and selectable options relating to the corresponding tools/systems 104, in certain alternate embodiments, the UI 102u may be user customizable to include or present only the particular portions 102p-1, 102p-2, 102p-3, 102p-4, and/or 102p-5 that the user desires to view. For example, the UI 102u may provide user selectable options for enabling or disabling the display of any of portions 102p-1, 102p-2, 102p-3, 102p-4, and 102p-5. This modular approach allows users to create individual views for specific tasks, making the extension system 105 flexible and user-friendly.

Although FIG. 2A illustrates the portion 102p of the UI 102u of the IDE 102 as being delineated to include the portions 102p-1 through 102p-5, in certain alternate embodiments, the portion 102p may not be delineated as such, but may present (e.g., all) data and selectable options relating to the corresponding tools/systems 104 in a single area of the UI 102u.

It is to be understood and appreciated that, although one or more of FIGS. 1, 2, and 2A to 2O might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, etc. may have been illustrated in one or more of FIGS. 1, 2, and 2A to 2O as separate components, devices, systems, modules, etc., it will be appreciated that multiple components, devices, systems, modules, etc. may be implemented as a single component, device, system, module, etc., or a single component, device, system, module, etc. may be implemented as multiple components, devices, systems, modules, etc. Additionally, functions described as being performed by one component, device, system, module, etc. may be performed by multiple components, devices, systems, modules, etc., or functions described as being performed by multiple components, devices, systems, modules, etc. may be performed by a single component, device, system, module, etc.

Referring to FIG. 2P, an example process 236 is illustrated.

At 236a, the process may include receiving information relating to a user input from an IDE. For example, a first plugin 106 or a first AI agent 116 of the extension system 105 may, similar to that described above with respect to one or more of FIGS. 1 to 2O, perform one or more operations that include receiving information relating to a user input from the IDE 102.

At 236b, the process may include deriving a first instruction based on the information for directing a first external tool to perform one or more actions, wherein the first external tool provides functionality for managing one stage of an SDLC. For example, the first plugin 106 or the first AI agent 116 may, similar to that described above with respect to one or more of FIGS. 1 to 2O, perform one or more operations that include deriving a first instruction based on the information for directing a first external tool to perform one or more actions, wherein the first external tool provides functionality for managing one stage of an SDLC. For instance, the first external tool may be the SCM and/or CI tool/system 104-3 that manages the build stage of the SDLC, and the one or more actions may be to commit source code.

At 236c, the process may include sending the first instruction to the first external tool to trigger the first external tool to perform the one or more actions. For example, the first plugin 106 or the first AI agent 116 may, similar to that described above with respect to one or more of FIGS. 1 to 2O, perform one or more operations that include sending the first instruction to the first external tool to trigger the first external tool to perform the one or more actions.

At 236d, the process may include responsive to the sending, obtaining, from the first external tool, data relating to performing of the one or more actions. For example, the first plugin 106 or the first AI agent 116 may, similar to that described above with respect to one or more of FIGS. 1 to 2O, perform one or more operations that include responsive to the sending, obtaining, from the first external tool, data relating to performing of the one or more actions. For instance, the data may include a completion report relating to committal of the source code by the SCM and/or CI tool/system 104-3.

At 236e, the process may include deriving a second instruction based on the data for directing a second external tool to perform one or more other actions, wherein the second external tool provides functionality for managing another stage of the SDLC. For example, a second plugin 106 or a second AI agent 116 of the extension system 105 may, similar to that described above with respect to one or more of FIGS. 1 to 2O, perform one or more operations that include deriving a second instruction based on the data for directing a second external tool to perform one or more other actions, wherein the second external tool provides functionality for managing another stage of the SDLC. For instance, the second external tool may be the planning tool/system 104-1 that manages the planning stage of the SDLC, and the one or more other actions may be to update a ticket or to update a project status.

At 236f, the process may include sending the second instruction to the second external tool to trigger the second external tool to perform the one or more other actions, thereby facilitating centralized access to and control of operations of different external tools associated with different stages of the SDLC. For example, the second plugin 106 or the second AI agent 116 may, similar to that described above with respect to one or more of FIGS. 1 to 2O, perform one or more operations that include sending the second instruction to the second external tool to trigger the second external tool to perform the one or more other actions. The process thereby facilitates centralized access to and control of operations of different external tools associated with different stages of the SDLC. In one or more embodiments, such centralized access/control may include or involve the use of consistent (e.g., API-based) system access and data transmission protocols across the external tools, which mitigates vulnerabilities associated with data breaches or the like that would otherwise be prevalent if the user were to separately access the individual external tools using different access methods. Such centralized access/control also improves computer functionality by streamlining data access and reducing the computational overhead that might otherwise result from the user running applications to open or access the different interfaces of the external tools. By centralizing data exchanges with/between the external tools, therefore, the extension system 105 efficiently controls interactions with/between the various tools, which reduces the possibility of redundant data requests and processing, thereby providing for more efficient memory and processing power usage.

While for purposes of simplicity of explanation, the respective processes are shown and described as a series of blocks in FIG. 2P, it is to be understood and appreciated that the claimed subject matter is not limited by the order of the blocks, as some blocks may occur in different orders and/or concurrently with other blocks from what is depicted and described herein. Moreover, not all blocks would necessarily be required to achieve the desired functionality in all cases.

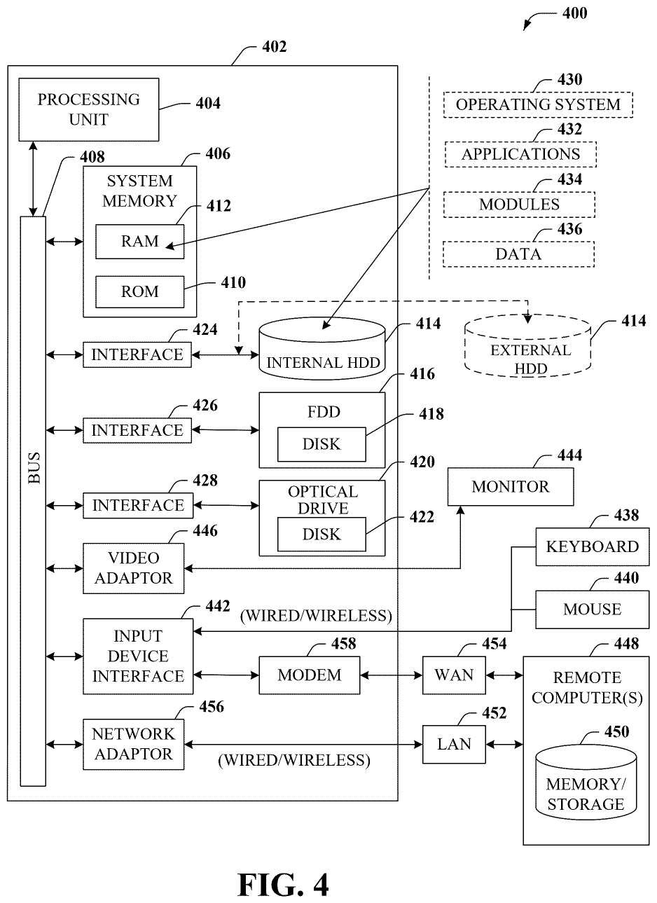

Referring to FIG. 3A, an example AI architecture 350 may be used to facilitate training and/or pre-training of AI models, such as AI model(s) of the AI system 109 and/or the AI agents 116 described above with respect to FIGS. 2 and 2O. For instance, the AI architecture 350 may be used to facilitate training and/or pre-training of an LLM of the AI system 109 and/or the AI agents 116, such as an LLM that is based on the transformer model 380 illustrated in FIG. 3B and described in more detail below. The AI architecture 350 may include an input module 352, a preprocessor 354, and a training module 356. Some or all of these modules, which may be referred to as programs, processors, or agents, may be realized based on execution of instructions or data by one or more processors of a computing (or machine learning (ML)) system, such as the computing system 400 of FIG. 4 (described in more detail below).

The input module 352 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 350 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 354 may be equipped with one or more preprocessing algorithms that are configured to prepare input datasets for processing by the training module 356. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 356 may be configured to train and evaluate ML models. As an example, the training module 356 may be configured to perform unsupervised learning and/or supervised learning based in input datasets. In exemplary embodiments, the training module 356 may be capable of training and/or evaluating the performance of multiple models in parallel. In one or more implementations, the training module 356 may, despite operating on multiple ML models in parallel, train and evaluate the various ML models individually. In some implementations, the training module 356 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 350 to train deep learning neural network model(s) to output predictions. Although not shown, the AI architecture 350 may include additional functional modules, such as those for gathering performance results and presenting (e.g., displaying) data regarding the results. While various components, modules, etc. may have been illustrated in FIG. 3A as separate components, modules, etc., it will be appreciated that multiple components, modules, etc. may be implemented as a single component, module, etc., or a single component, module, etc. may be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 3B, an example transformer model 380 (a portion or an entirety of which may serve as a functional building block of one or more LLMs (e.g., LLM(s) of the AI system 109 described above with respect to FIG. 2 and/or associated with the AI agents 116 described above with respect to FIG. 2O)) may include an encoder 382 and a decoder 384. The encoder 382 may include an input embedding block 382b, a positional encoder 382c, and a series of (i.e., multiple (Nx)) identical layers that each has a multi-head attention block 382m and a feed forward block 382f. An input (e.g., text, such as a query or a prompt) may be converted into individual tokens (e.g., words, characters, etc.) that are fed into the input embedding block 382b. The input embedding block 382b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 382c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 382b on an element-by-element basis, resulting in a processed input that may be fed into the series of layers. The processed input may be fed into the multi-head attention block 382m in the first layer. An addition (or residual connection) and normalization block 382x may operate on the processed input and the output of that multi-head attention block 382m. The output of the addition and normalization block 382x may be passed to the feed forward block 382f in that layer. An addition and normalization block 382y may operate on the output of the addition and normalization block 382x and the output of the feed forward block 382f. In essence, the multi-head attention block 382m of a given layer may enable the feed forward block 382f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 384 may include an output embedding block 384b, a positional encoder 384c, and a series of (i.e., multiple (Mx)) identical layers that each has a masked multi-head attention block 384k, a multi-head attention block 384m, and a feed forward block 384f. An output (shifted right) may be converted into individual tokens that are fed into the output embedding block 384b. The output embedding block 384b may convert the tokens into continuous vectors. The positional encoder 384c may derive fixed positional encodings or learned positional encodings to help capture positional information of tokens. The processed output may be fed into the masked multi-head attention block 384k in the first layer. An addition and normalization block 384w may operate on the processed output and the output of that masked multi-head attention block 384k. The output of the addition and normalization block 384w may be passed to the multi-head attention block 384m in that layer. Output(s) from the encoder 382 may also be fed into the multi-head attention block 384m. An addition and normalization block 384x may operate on the output of the addition and normalization block 384w and the output of multi-head attention block 384m. The output of the addition and normalization block 384x may be passed to the a feed forward block 384f in that layer. An addition and normalization block 384y may operate on the output of the addition and normalization block 384x and the output of the feed forward block 384f. The output of the addition and normalization block 384y may may be passed to a linear layer 384r, which may transform that output into a higher-dimensional space. The output of the linear layer 384r may be fed into a softmax layer 384s, which may be a non-linear activtion function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 382 and/or the decoder 384 in particular arrangements and in combination with additional refinements/components. A given LLM constructed as such may then be trained or pre-trained (e.g., using the AI architecture 350 of FIG. 3A, a similar AI architecture, a different AI architecture or a combination of some or all of these AI architectures) on a corpus of information and/or finetuned or instruction-tuned to analyze/generate data (e.g., text, audio, and/or images).

While FIG. 3B illustrates a representative encoder-decoder architecture, it will be understood and appreciated that other architecture(s) may additionally, or alternatively, be used, such as those that include encoder-only model(s), decoder-only model(s), hybrid or specialized variants (e.g., retrieval-augmented or multimodal systems), etc.

Referring to FIG. 4, a computing environment 400 is illustrated. In various embodiments, computing environment 400 can facilitate, in whole or in part, integration of an IDE (e.g., the IDE 102) with various tools/systems (e.g., tools/systems 104) that are used across different stages of an SDLC.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring again to FIG. 4, the example environment 400 can include a computer 402, the computer 402 including a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 includes ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also include a high-speed RAM such as static RAM for caching data.

The computer 402 further includes an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, including an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can include a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically includes other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically includes many or all of the elements described relative to the computer 402, although, for purposes of brevity, only a remote memory/storage device 450 is illustrated. The logical connections depicted include wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also include a wireless AP disposed thereon for communicating with the adapter 456.

When used in a WAN networking environment, the computer 402 can include a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. It is also to be understood and appreciated that the subject matter in one or more dependent claims may be combined with that in one or more other dependent claims.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can include the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner that can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A method, comprising:
receiving, by a processing system including a processor, information relating to a user input from an integrated development environment (IDE);
deriving, by the processing system, a first instruction based on the information for directing a first external tool to perform one or more actions, wherein the first external tool provides functionality for managing one stage of a software development lifecycle (SDLC);
sending, by the processing system, the first instruction to the first external tool to trigger the first external tool to perform the one or more actions;
responsive to the sending, obtaining, by the processing system and from the first external tool, data relating to performing of the one or more actions;
deriving, by the processing system, a second instruction based on the data for directing a second external tool to perform one or more other actions, wherein the second external tool provides functionality for managing another stage of the SDLC; and
sending, by the processing system, the second instruction to the second external tool to trigger the second external tool to perform the one or more other actions,
thereby facilitating centralized access to and control of operations of different external tools associated with different stages of the SDLC.

2. The method of claim 1, wherein the method is performed based on instructions included in at least one plugin of an extension system that is integrated with the IDE, and wherein the at least one plugin comprises a first plugin that is configured to interact with the first external tool and a second plugin that is configured to interact with the second external tool.

3. The method of claim 1, wherein the method is performed via at least one artificial intelligence (AI) agent of an extension system that is integrated with the IDE.

4. The method of claim 1, wherein the first external tool or the second external tool comprises a planning tool, a documentation tool, a source code management (SCM) or continuous integration (CI) tool, a continuous deployment (CD) tool, or a deployment environment.

5. The method of claim 1, wherein the IDE comprises at least one of an application programming interface (API) or a command line interface (CLI), and wherein the receiving is performed via the at least one of the API or the CLI.

6. The method of claim 1, wherein the first external tool or the second external tool comprises at least one of an application programming interface (API) or a command line interface (CLI), and wherein the sending the first instruction or the sending the second instruction is performed via the at least one of the API or the CLI.

7. The method of claim 1, wherein the user input is received via a user interface (UI) of the IDE.

8. The method of claim 1, wherein the user input comprises a command to create, update, or store documentation data, wherein the first external tool comprises a documentation tool, and wherein the one or more actions comprise creating, updating, or storing the documentation data.

9. The method of claim 1, wherein the user input comprises a request to commit source code or a branch of source code, wherein the first external tool comprises a source code management (SCM) tool, and wherein the one or more actions comprise committing the source code or the branch of source code.

10. The method of claim 1, wherein the user input comprises a request to trigger a build for source code or a branch of source code, wherein the first external tool comprises a source code management (SCM) tool, a continuous integration (CI) tool, or a combination thereof, and wherein the one or more actions comprise performing the build for the source code or the branch of source code.

11. The method of claim 1, wherein the user input comprises a command to submit a pull request for source code or a branch of source code, wherein the first external tool comprises a source code management (SCM) tool, a continuous integration (CI) tool, or a combination thereof, and wherein the one or more actions comprise creating the pull request for the source code or the branch of source code.

12. The method of claim 1, wherein the user input comprises a command to deploy source code or a branch of source code, wherein the first external tool comprises a deployment tool, and wherein the one or more actions comprise deploying the source code or the branch of source code.

13. The method of claim 1, wherein the second external tool comprises a planning tool, and wherein the one or more other actions comprise updating a status of a project task.

14. A device, comprising:
a processing system including a processor; and
a memory that stores executable instructions that, when executed by the processing system, facilitate performance of operations, the operations comprising:
detecting a user command from an integrated development environment (IDE);
causing a first external tool to perform one or more actions based on the user command, wherein the first external tool provides functionality for managing one stage of a software development lifecycle (SDLC);
receiving data from the first external tool relating to performing of the one or more actions;
based on the data, causing a second external tool to perform one or more other actions, wherein the second external tool provides functionality for managing another stage of the SDLC;
obtaining information from the second external tool relating to performing of the one or more other actions; and
causing the IDE to present one or more of the data or the information on a user interface (UI) of the IDE, thereby facilitating centralized access to and control of operations of different external tools associated with different stages of the SDLC.

15. The device of claim 14, wherein the first external tool comprises a continuous deployment (CD) tool, and wherein the data includes a deployment log relating to deployment of an application.

16. The device of claim 14, wherein the first external tool comprises a deployment environment, and wherein the data includes information regarding a deployed application.

17. The device of claim 14, wherein the second external tool comprises a planning tool, and wherein the one or more other actions comprise updating a status of a project task.

18. A non-transitory machine-readable medium, comprising executable instructions that, when executed by a processing system including a processor, facilitate performance of operations, of which the operations comprise:
receiving information relating to a user input from an integrated development environment (IDE);
deriving a first instruction based on the information for causing a first external tool to perform one or more actions, wherein the first external tool is associated with management of one or more stages of a software development lifecycle (SDLC);
sending the first instruction to the first external tool to trigger the first external tool to perform the one or more actions;
responsive to the sending, obtaining, from the first external tool, data relating to performing of the one or more actions;
deriving a second instruction based on the data for causing a second external tool to perform one or more other actions, wherein the second external tool is associated with management of one or more other stages of the SDLC; and
providing the second instruction to the second external tool to trigger the second external tool to perform the one or more other actions,
thereby facilitating centralized access to and control of operations of different external tools associated with different stages of the SDLC.

19. The non-transitory machine-readable medium of claim 18, wherein the executable instructions are associated with at least one plugin that is integrated with the IDE, at least one AI agent that is integrated with the IDE, or a combination thereof.

20. The non-transitory machine-readable medium of claim 18, wherein the first external tool or the second external tool comprises a planning tool, a documentation tool, a source code management (SCM) or continuous integration (CI) tool, a continuous deployment (CD) tool, or a deployment environment.
